(19) United States
(12) Patent Application Publication
(10) Pub. No.: US 2010/0153160 A1
(43) Pub. Date: Jun. 17, 2010

(54) SYSTEM FOR SUPPORTING COORDINATION OF RESOURCES FOR EVENTS IN AN ORGANIZATION

(75) Inventors: RICHARD BEZEMER, Calgary (CA); SHYMMON BANERJEE, Calgary (CA); UMAR FAROOQ, Calgary (CA); CHRISTIAN SMITH, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART Technologies ULC, Calgary (CA)

(21) Appl. No.: 12/629,319

(22) Filed: Dec. 2, 2009

Related U.S. Application Data
(60) Provisional application No. 61/122,107, filed on Dec. 12, 2008.

(51) Int. Cl. G06Q 10/00; G06Q 50/00

(52) U.S. Cl. 705/8; 705/301; 705/348

(57) ABSTRACT

A system and method for supporting coordination of resources for events in an organization includes a knowledge component storing a resource-utilization model, the resource-utilization model comprising at least one ontology, each ontology comprising a respective schema and data stored according to the schema; a knowledge acquisition component adapting the resource-utilization model in real-time in response to receiving data from various sources about resource utilization in the organization; a domain reasoner adapting the resource-utilization model based on contents of a modifiable set of rules applied by the organization; and a query endpoint receiving queries about resources for events and responding to the queries based on the resource-utilization model.

### CROSS REFERENCE TO RELATED APPLICATIONS

This application claims priority under 35 U.S.C. 119(e) from U.S. Provisional Patent Application Ser. No. 61/122,107; which was filed on Dec. 12, 2008.

### FIELD OF THE INVENTION

The present invention relates generally to resource management and in particular to a system and method for supporting coordination of resources for events in an organization.

### BACKGROUND OF THE INVENTION

Meeting scheduling software products are well-known. Microsoft® Outlook® Calendar, EmergingSoft MeetingPlanner™, NetSimplicity Meeting Room Manager™, CyberMatrix® Meeting Manager™, and OfficeTracker™ are just some examples of the available meeting scheduling software products. Various meeting scheduling software products are capable of permitting access to pre-arranged schedules of an organization's resources, such as its employees and other people with whom the organization works, its meeting rooms, and its equipment. While planning a meeting, users of the scheduling software products are able to search for and view the schedules of the prospective participants and other resources in order to find one or more feasible time slots during which the prospective participants and the other resources may be scheduled. A user can then schedule a meeting during one of the feasible time slots, notify the participants, and reserve the resources.

It is known to provide a user with tools for easing the process of locating a feasible time slot for scheduling a meeting. For example, using Microsoft® Outlook® 2007, after having specified the meeting participants and other desired resources for a particular meeting, a user is able to invoke a Meeting Assistant that iterates through each half-hour time slot, determines the number of participants and other resources that are indicated as available during each time slot, and reports time slots to the user in the order of earliest availabilities. The user can then select the time slot for the meeting.

Other tools facilitate negotiation between users about meeting times. Negotiation may be done via email or by voting on a website. Examples of such tools include Meeting Wizard, Meetomatic, AgreeADate, Doodle, Pointment and TimeToMeet.

While the above-described meeting scheduling software can be useful, improvements are of course desirable. For example, such tools do not adapt well to changes in availability of participants and other resources that are inevitable in today's busy corporate or other organizations. For example, occasionally it is desirable to coordinate resources on a last-minute or ad-hoc basis in order to meet with people about an unexpected issue. Furthermore, many groups in organizations compete for limited numbers of resources such as meeting rooms, equipment, software resources, multimedia resources, including resources such as voice bridges, conferencing cameras, interactive technology, etc., and often participants maintain busy and ever-changing workplace schedules, moving back and forth between more than one corporate office locations throughout a given month, week, or day as needs arise.

Under these circumstances, it is challenging for a meeting planner, even with the tools available, to coordinate suitable resources for meetings during a specified date/time range. For example, the meeting scheduling software known in the art is unsuitable under these circumstances for achieving a high success rate of feasible meeting times with desired resources because the information available about the resources is static. Effective scheduling relies on the user planning the meeting having been explicitly informed about a change in a resource's utilization, such as its availability, location, operability, or scheduling, and then going through the oftentimes tedious process of coordinating the resources for a meeting at another suitable date and time.

The meeting scheduling software in the art is also unable to adapt to its users' respective preferences and schedules. Repeatedly scheduling meetings then becomes cumbersome because users have to go through a number of settings each time. Furthermore, the meeting scheduling software known in the art is not capable of fully adapting to changes in an organization's structure and policies, meeting resources, and functional requirements. When a significant change within the organization occurs, having the change reflected in known meeting scheduling software products requires either a software upgrade, or a full or partial redeployment of the product. Moreover, the meeting scheduling software known in the art lacks of the ability to integrate various sources of information for detecting the availability status of people, meeting room and resources in real-time, and for adapting to any status changes in real-time for meeting scheduling.

It is therefore an object of the present invention to provide a system for supporting coordination of resources for events in an organization that overcomes the above deficiencies.

### SUMMARY OF THE INVENTION

According to one aspect there is provided a system for supporting coordination of resources for events in an organization, comprising:

a knowledge component storing a resource-utilization model, the resource-utilization model comprising at least one ontology, each ontology comprising a respective schema and data stored according to the schema;

a knowledge acquisition component adapting the resource-utilization model in real-time in response to receiving data from various sources about resource utilization in the organization;

a domain reasoner adapting the resource-utilization model based on contents of a modifiable set of rules applied by the organization; and

a query endpoint receiving queries about resources for events and responding to the queries based on the resource-utilization model.

According to another aspect there is provided a method for supporting coordination of resources for events in an organization, comprising:

providing a resource-utilization model, the resource-utilization model comprising at least one ontology, each ontology comprising a respective schema and data stored according to the schema;

adapting the resource-utilization model in real-time in response to receiving data from various sources about resource utilization in the organization;

adapting the resource-utilization model based on contents of a modifiable set of rules applied by the organization;

receiving queries about resources for events; and

responding to the queries based on the resource-utilization model.

According to another aspect there is provided a computer readable medium embodying a computer program for supporting coordination of resources for events in an organization, the computer program comprising:

computer program code providing a resource-utilization model, the resource-utilization model comprising at least one ontology, each ontology comprising a respective schema and data stored according to the schema;

computer program code adapting the resource-utilization model in real-time in response to receiving data from various sources about resource utilization in the organization;

computer program code adapting the resource-utilization model based on contents of a modifiable set of rules applied by the organization;

computer program code receiving queries about resources for events; and

computer program code responding to the queries based on the resource-utilization model.

The system and method described herein provide support for applications that involve coordination of resources for events. Such applications include those to be used for scheduling meetings, for example. The system and method described herein enable the incorporation of user preferences, meeting room availability, and optimization of the resources. Furthermore, the system and method described herein enable the automatic undertaking of many of the tedious and iterative tasks of event scheduling and manually modifying event scheduling.

### BRIEF DESCRIPTION OF THE DRAWINGS

Embodiments will now be described more fully with reference to the accompanying drawings in which:

FIG. 1 is a schematic diagram of a system for supporting coordination of resources for events, according to an embodiment;

FIG. 2 is a schematic diagram showing the structure of an ontology;

FIG. 3 is a schematic diagram of a scheduling system incorporating a system for supporting coordination of resources for events;

FIG. 4a is a concept diagram showing the structure of an RDF file;

FIG. 4b is a listing of an exemplary RDF file;

FIGS. 5a and 5b are listings of an exemplary SPARQL query and corresponding query results, respectively;

FIG. 5c is a listing of exemplary query results with a “ServiceNotFound” message corresponding to a SPARQL query searching for an unavailable service;

FIG. 6 is a workflow diagram illustrating the process by which a user uses the meeting scheduler application to schedule a meeting;

FIGS. 7a-7f are screenshots of the user interface generated by the meeting scheduler application for use for scheduling a meeting;

FIG. 8 is a screenshot of the meeting scheduler user interface during updating user location information;

FIG. 9 is a screenshot of the meeting scheduler user interface during configuring of options;

FIG. 10 is a screenshot of an information kiosk user interface;

FIGS. 11a-11d are screenshots of the information kiosk user interface displaying a floor map of an organization;

FIG. 12 is a screenshot of the information kiosk user interface displaying a dialog for searching for a person;

FIG. 13 is a screenshot of an administrative portion of the information kiosk user interface for setting up rooms in the resource-utilization model;

### DETAILED DESCRIPTION OF THE EMBODIMENTS

In the following, a system for coordinating resources for events in an organization is described. A semantics-based framework is built to collect information from a variety of sources and synthesize additional information using domain reasoning. Meeting management applications such as for example a meeting scheduler and meeting management dashboard are then built on the semantics-based framework. The resulting meeting management system is thereby evolvable and adaptable to requirement changes. Based on the semantics-based framework, the meeting management system provides users with a high degree of flexibility in scheduling meetings, while improving the user's ability to more efficiently use resources and facilities.

The semantic framework organizes information collected from various sources into one or more ontologies, and thereby provides a coherent view of a large set of disparate event-related information for an organization. For example, machine learning algorithms extract meeting related information from unstructured source such as for example, emails, meeting agenda and meeting minutes. Advantageously, by defining the inter-relationships between ontologies, the semantic framework facilitates synthesis of additional information. The information synthesis procedure results in additional model knowledge to be gleaned from the acquired data.

The functionality of the semantic framework described above thus provides an underpinning for rapid creation and seamless integration of different meeting management applications. Moreover, as a consequence of dynamic knowledge sharing, the meeting management applications enhance meeting related workflows.

Based on the semantic framework, the meeting management system adapts to the organization's policies and requirements. When the requirements for the organization change, or when new policies and/or concepts are added with the deployment of new applications in the organization, the semantics-based meeting management system is capable of easily adapting without recompiling the program or redeploying the system. In particular, the meeting management system integrates machine learning algorithms with a description logic reasoner to dynamically adapt the behaviour of meeting management applications. Advantageously, the system employs a Logic Partitioning technique to achieve reach high scalability and flexibility, as will be described. An architecture is also provided for a highly evolvable and maintainable interface and software development kit (SDK) to facilitate the integration of the meeting management system with other semantics-based applications.

Based on the semantic framework, the meeting management system significantly automates the process of scheduling meetings in organizations. It provides adjustable autonomy, performance optimization, evolvability, learning ability, dynamic adaptability, uncertainty handling and automatic information propagation. The meeting management system also dynamically shares knowledge with other meeting management applications. With these features, the meeting management system is capable of saving users significant amounts of effort and time coordinating meetings. Furthermore, resource and time utilization is increased, and organizational workflows are enhanced.

Advantageously, when using the meeting scheduler of the meeting management system to schedule a meeting, the user is required only specify high-level requirements. In turn, the meeting scheduler will determine the details of the meeting such as feasible times, locations, and available rooms and resources for the meeting. Furthermore, the meeting scheduler is capable of adapting to a user's preferences by inferring and evolving the user's preference patterns, and by providing a set of meeting resources that, given constraints on the system, is determined to best match the user's preferences. Default option(s) from which the user can start can thereby be established. The user may accept the default option or select one of the other feasible options to book the meeting. The user may also let the scheduler automatically book a meeting according to the user's requirements and preferences such that the utilization of the resources and time is maximized.

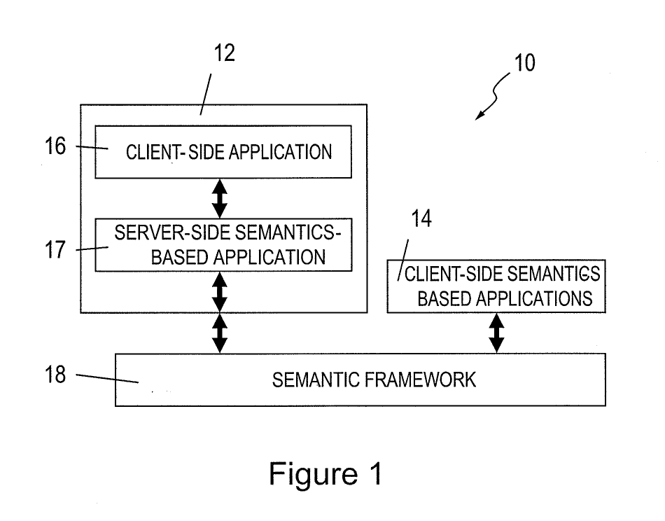

Turning now to FIG. 1, a schematic diagram of a meeting management system is shown and is generally identified by reference numeral 10. The system 10 comprises a semantic framework layer 18 and a plurality of semantics-based applications. The semantics-based applications may be client-side semantics-based applications 14, or server applications 12 that each comprises a client-side application 16 and a server-side semantics-based application 17. For example, a client-side application 16 receives queries from users relating to scheduling of events, communicates with the server-side semantics-based application 17 to obtain query results based on a resource-utilization model, and provide query results to users.

The semantic framework layer 18 stores and manages information ontologies and rules. The semantics-based applications 12 and 14 interact with each other (not shown) and/or with the user (not shown) by sending queries and responding to queries with relevant results. The server-side semantics-based applications 17 communicate with the semantic framework layer 18 to retrieve ontologies and rules to obtain the information about where and how to gather data to form the results for the queries they receive. The client-side semantics-based applications 14 also communicate with the semantic framework layer 18 by sending queries to, and receiving query results from, the semantic framework layer 18.

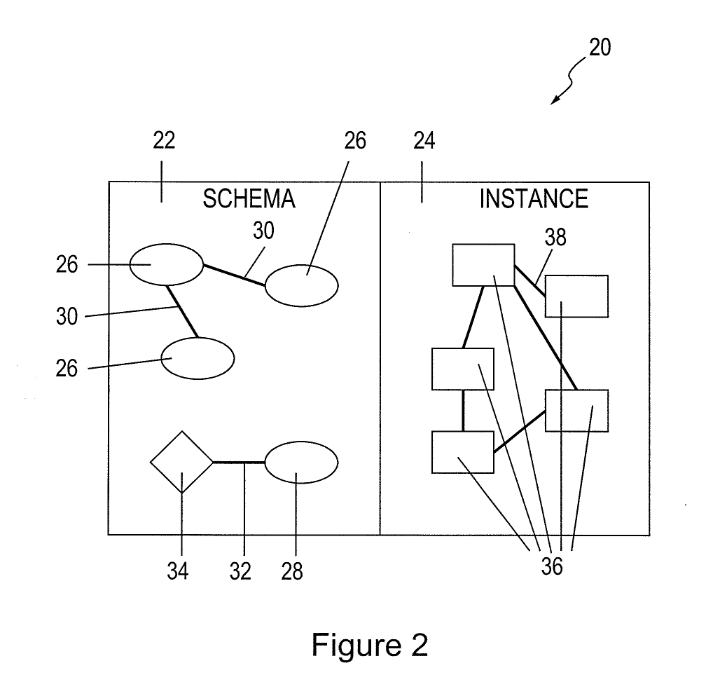

The semantics-based meeting management system manages meeting information by employing a resource utilization model that organizes the information into a plurality of meeting and scheduling ontologies. An ontology may include a representation of a set of concepts and their relationships. FIG. 2 illustrates the structure of an ontology generally identified by reference numeral 20. The ontology is logically divided into a schema portion 22 and an instance portion 24. The schema portion 22 defines a set of concepts 26 and 28, such as for example meeting-related concepts including meetings and resources such as rooms, people (i.e. employees, visitors etc.), organization, software, equipment and multimedia resources. The schema portion 22 also defines and captures relationships 30 and 32 between concepts, such as for example belongsTo, startsAt, as well as constraints and restrictions (not shown) that govern the nature of the relationships. The instance portion 24 contains data representing the instances or individuals 36 of concepts along with their relationship (e.g., 38 in FIG. 2) to other individuals according to the concepts, interrelationships and constraints in schema portion 22. Each concept, relationship or individual is assigned a system-wide (or network-wide) unique ID. The ontologies can be defined using Web Ontology Language (OWL) in which case each concept has a Uniform Resource Identifier (URI) as a unique ID.

For scalability and ease of future modifications, a set of tightly related concepts and their corresponding individuals are defined together in an ontology. For example, meeting-related concepts are defined in the Meeting ontology, and scheduling related concepts are defined in the Scheduling ontology. Of course, concepts in a first ontology may have relationships with concepts defined in other ontologies. In this case, the first ontology explicitly refers to those concepts in other ontologies, instead of incorporating duplicates of the concepts. For example, as shown in FIG. 2, the ontology 20 contains a concept 28 that has a relationship 32 with the reference 34, which refers to a concept in another ontology (not shown). The ontologies defined in the semantics-based meeting management system provide a uniform view, or structure, for the meeting domain.

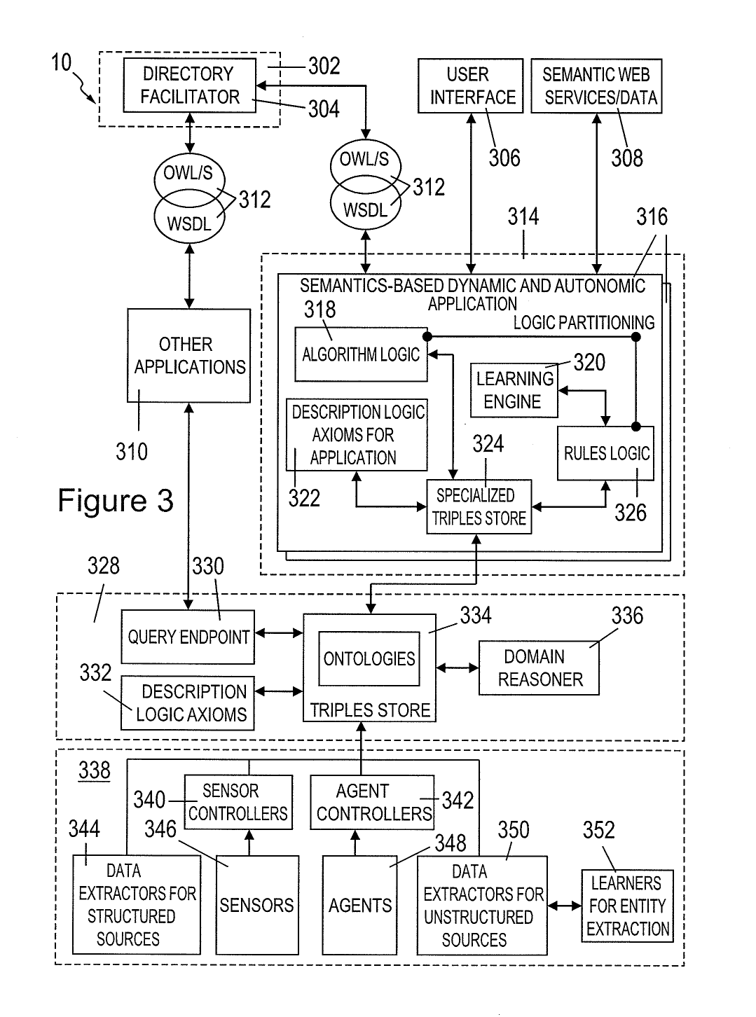

FIG. 3 illustrates the software structure of the semantics-based meeting management system 10. System 10 comprises at least one directory server 302 and at least one knowledge component, or server 328. In this embodiment, the system 10 also includes at least one semantic web application server 314 that runs at least one semantics-based dynamic and autonomic application 316. The server-side application 316 communicates with one or more client-side applications such as for example a user interface application 306 to receive user's queries and send query result to the server-side application 316. In another embodiment, the system 10 may not contain a semantic web application server 314, and instead may directly communicate with client-side applications.

One or more other applications 310 such as for example browser-based client-side applications and third-party applications (which may be server-based or client-based, and may or may not be semantics-based) communicate with the directory server 302 and the knowledge server 328 to query information to perform their tasks. The system 10 obtains data input from the user interface 306, other semantics-based applications 310, and the knowledge acquisition component, or layer 338. The output of the system 10 is sent to the user interface 306 and/or other applications 310 to, for example, update schedules of user(s), reserve meeting facilities, prepare meeting resources, notify users of a meeting schedule, send reminders for an upcoming meeting, send users information related to a meeting, and/or reply to user queries with query results such as for example feasible schedules, location of a person, etc.

Input data is fed into the system 10 via the user interface 306 and the knowledge acquisition component 338 for setting up meeting schedules and/or querying meeting information. In one embodiment, the user interface 306 is implemented in a browser based application. The knowledge acquisition layer 338 extracts input data that conforms to ontologies and sends the data to the knowledge server 328 to form instances in the ontologies. Various data acquisition components may be included in the knowledge acquisition layer 338, such as for example, data extractors for structured sources 344, sensors such as for example Radio-Frequency IDentification (RFID) sensors, software agents such as for example a meeting management dashboard, and data extractors for unstructured sources 350. Those skilled in the art will appreciate that other data acquisition components may also be used in the knowledge acquisition layer 338. The data acquisition components may be distributed on the server side and/or on the client side.

Data extractors for structured sources 344 acquire data from various structured data sources, such as Microsoft® Exchange Server®, LDAP (Lightweight Directory Access Protocol), relational and/or other kinds of databases and XML Documents, by using techniques such as for example Database to RDF (D2R) Maps, Gleaning Resource Descriptions from Dialects of Languages (GRDDL) and/or custom codes. The acquired data are then converted to triples. As would be understood, triples are expressions in the form of: subject-predicate-object. The triples are stored in the triples store 334 in the knowledge server 328.

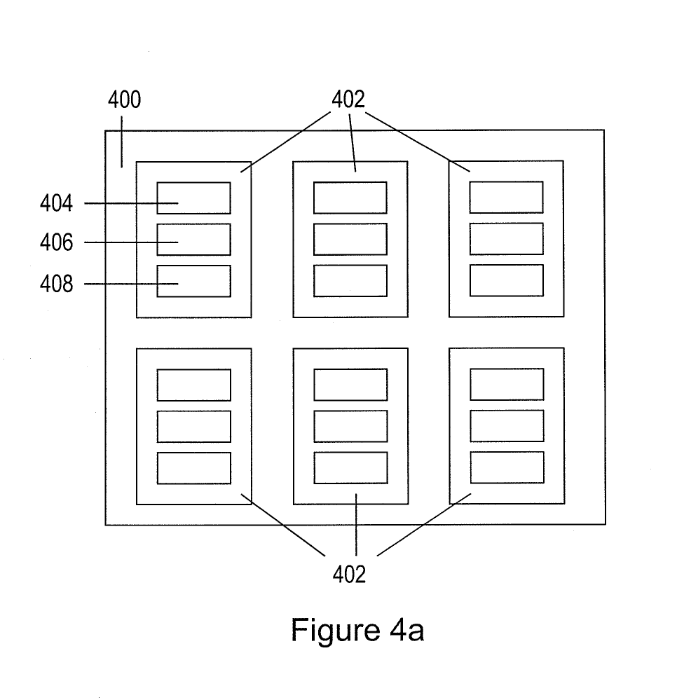

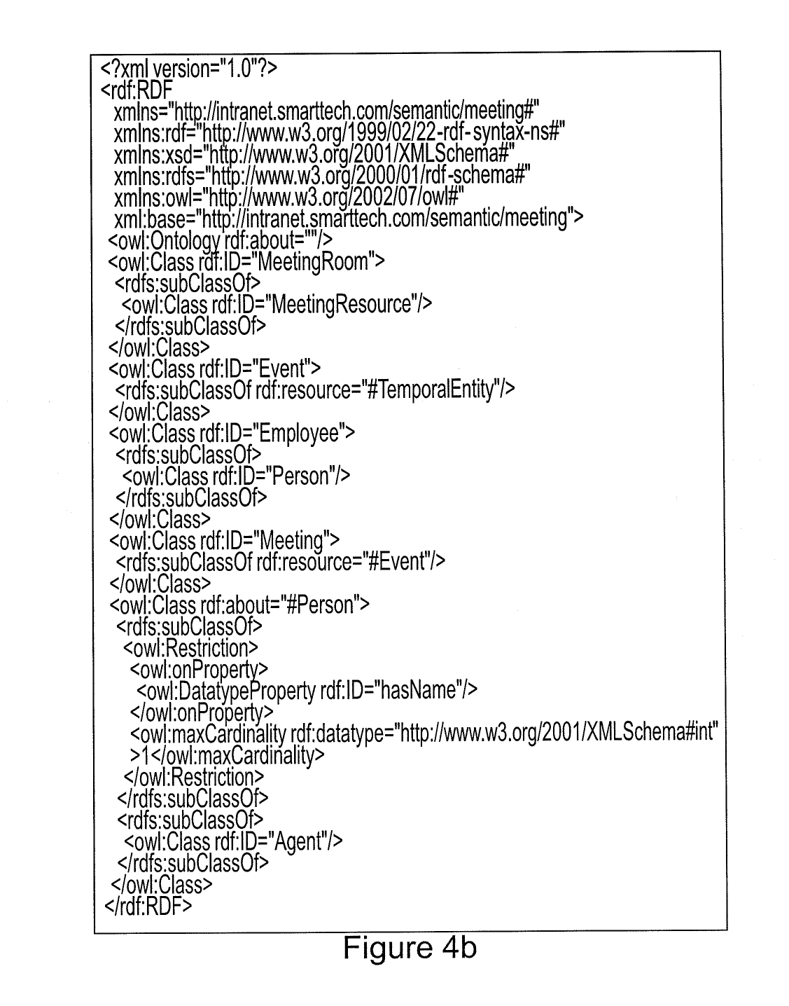

One well-known triples format is the Resource Description Framework (RDF) format. FIG. 4a is a listing showing the structure of an RDF file 400. The RDF file 400 contains a plurality of triples 402. Each triple 402 includes a subject 404, which identifies the object that the triple describes, a predicate 406, which identifies a property of the subject that the triple describes, and an object 408, which is the value assigned to the property of the subject. The concepts and abstract syntax of RDF are given in W3C website (http://www.w3.org/TR/rdf-concepts/), the contents RDF file is shown in FIG. 4b.

Data acquired by sensors 346 are input into the sensor controllers 340. The sensor controllers 340 convert received data to triples format and store the converted data in the triples store 334.

Data acquired by software agents 348 are input into the agent controllers 342. The agent controllers 342 then convert received data to triples format and store the converted data in the triples store 334.

Data extractors for unstructured sources 350 acquire data from sources that do not organize meeting related information in a structured manner, such as for example, emails, memo, personal schedules, and documents/folders on the computer/network storage. Learners for entity extraction 352 that employing machine learning or other appropriate algorithms (eg., natural language processing algorithms, decision trees and neural network algorithms) guide the data extractors for unstructured sources 350 to extract data and convert data to triples format, and store the converted data in the triples store 334 in the knowledge server 328.

By using various data acquisition components, the knowledge server 328 collects, and updates in real-time, all types of meeting related information such as for example people's contact information, location and schedule, meeting room location, size and availability, voice bridge availability, other meeting facilities (e.g., interactive whiteboards, audio/video equipment, etc.), data communication servers and services, and scheduled meeting information (e.g., meeting name, participants, starting date/time, duration, booked meeting room(s) and meeting facilities, voice bridge and remote access information, participant preferences, corporate hierarchy, etc.). The resource utilization model is thereby adaptable in real-time to changes that occur with the resources, scheduling and so forth.

The knowledge server 328 comprises query endpoint 330, description logic axioms 332, domain rules and reasoner 336 and the triples store 334. The triples store 334 stores the schema and individuals of all defined ontologies. Each ontology is stored in a separate named graph in order to facilitate evolvability and scalability. The triples store 334 may be in the form of an in-memory triple store, one based on relational databases, or other appropriate types. In a preferred embodiment, a graph based database is used for the triples store 334 to facilitate scalability and efficiency. The triples store may be on a single server computer. However, when multiple server computers are deployed in the system 10, the triples store may be distributed on more than one server computers to obtain extra scalability and/or redundancy.

Description logic axioms 332 stores axioms that are used by the domain reasoner 336 to infer implicit information from the meeting related data that have been stored in the triples store 334 by the knowledge acquisition layer 338. The enrichment of data through knowledge synthesis results in more accurate and “smarter” behavior of semantics-based meeting applications. Description logic axioms 332 are also used to detect any discrepancies and contradictions in the data.

As would be understood, axioms are logic statements assumed to be true without proof. Axioms may be different depending on the description logic used. In a preferred embodiment, the description logic OWL-DL is used, which is based on SHOIN description logic that supports among other things role transitivity, role hierarchy, role inverses, nominals as well as unqualified number restrictions. Information can be inferred using description logic axioms when a query is made on the meeting data stored in the triples store. Alternatively, information can be inferred using description logic axioms and prepared for potential queries before any query is made.

For example, should Meeting have a property hasMeetingAttendee, an axiom might state that: hasMeetingOrganizer is a subProperty of hasMeetingAttendee. Using the axiom, the reasoner will infer that a Meeting will also have the MeetingOrganizer. Thus, either when user X is scheduling a meeting Y or afterwards, the meeting scheduler will exploit the inference, and automatically add the meeting organizer (user X) as a participant of the meeting Y thereby modifying the data without explicitly requiring user input on the matter.

Domain reasoner 336 also processes the data stored in triples store 334 in accordance with the policies and requirements of the organization in which the semantics-based meeting management system is deployed. The policies and requirements are expressed in the form of domain rules written using a rule description language. In a preferred embodiment, domain rules are written using the Semantic Web Rule Language (SWRL), which is a W3C standard for writing rules for OWL ontologies. For example, a rule written in SWRL Human Readable Syntax for finding locations at which meeting would take place is:
(?x rdf:type sm:Meeting) (?x sm:hasAttendee ?y) (?y sm:hasLocation ?z)->
(?x sm:takesPlaceAt ?z)

The above rule may be interpreted as follows: if a meeting x has an attendee y who has the location z, then the meeting will take place at the location z. The reasoning process may result in modification of the resource utilization model by way of addition, deletion and/or transformation of some meeting related data in the triples store without explicitly requiring user input on the matter during scheduling of a meeting or at another time.

Domain rules may be dynamically added, deleted or changed at the run-time to thereby adapt the resource utilization model to changes in user requirements without requiring recompiling or redeployment of any portion of the semantics-based meeting management system. In a preferred embodiment, domain rules are stored in at least one text file. Domain rules are loaded to the system every time the domain reasoner 336 is invoked, or when an information update is received from the knowledge acquisition layer 338. The system also monitors the domain rule file, and will automatically load the domain rule file whenever it is changed. In an alternative embodiment, the system periodically loads the domain rule file. To facilitate the deployment of the system, a set of default meeting rules are predefined in the set of rules, that may be customized to satisfy the requirement of a particular organization.

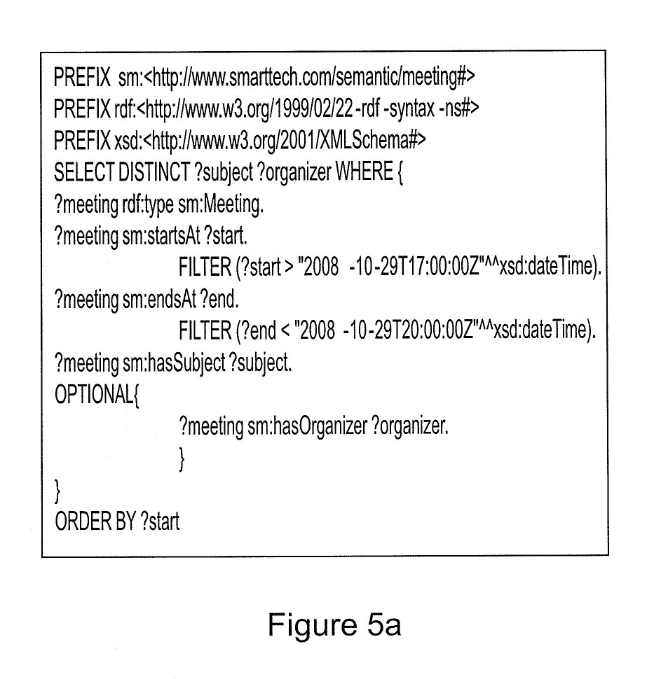

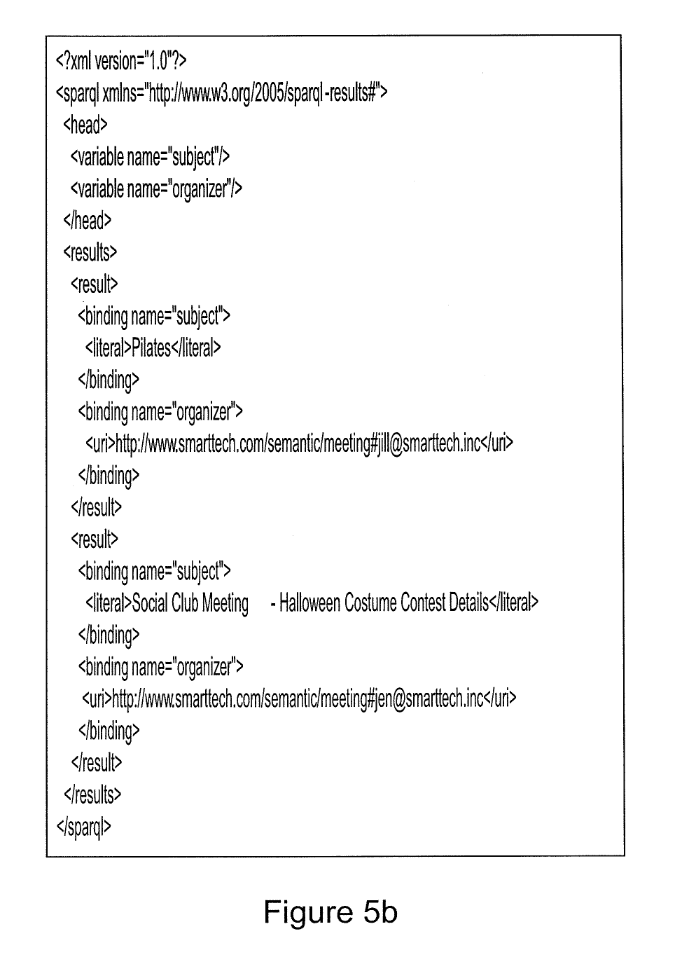

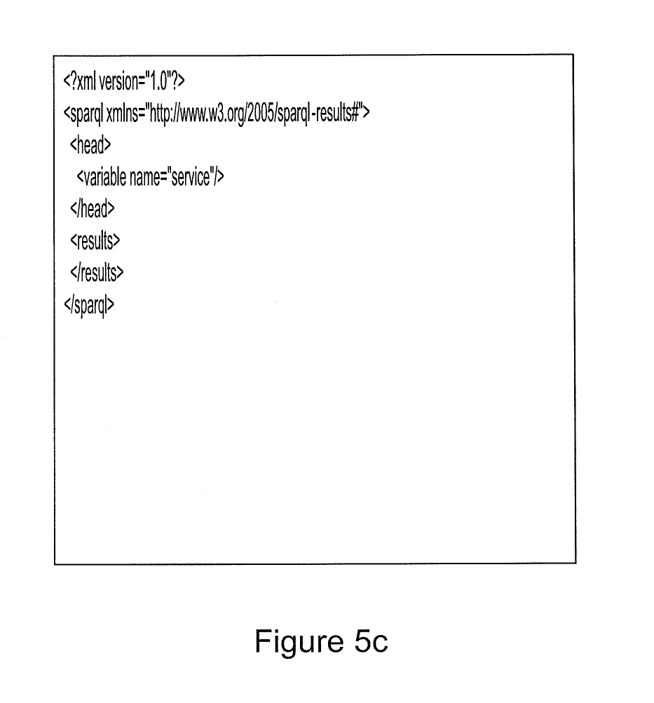

The query endpoint 330 provides a standardized interface for semantics-based applications 310 to query the data stored in the triples store 334 by using appropriate triples query languages. In a preferred embodiment, queries are formed by using the Simple Protocol and RDF Query Language (SPARQL), which is a W3C standard for querying RDF based triples store, and the results are returned in an XML format complying the W3C standard. FIG. 5a shows an exemplary SPARQL query that searches for the meetings starting after Nov. 29, 2008, 17:00 and ending before Nov. 29, 2008, 20:00. As illustrated in FIG. 5b, the query results show that two meetings are found.

The communication between the query endpoint 330 and other semantics-based applications 310 uses HTTP or a Simple Object Access Protocol (SOAP) based protocol because SPARQL standards support both HTTP and SOAP.

The querying mechanism implemented in the query endpoint 330 not only provides access to the meeting knowledge stored in the triples store 334, but also provide a method-invocation means to other semantics-based applications 310 to invoke methods that require access to specific meeting related data. The Query Endpoint acts as a software interface that other applications 310 (eg., third party applications) can access to obtain information from the knowledge server 328. Unlike traditional software interfaces that use an Application Programming Interface (API), the software interface provided by the query endpoint 330 is query-based. Due to the flexibility of query syntax, the software interface provided by the query endpoint 330 does not itself need to be revised to adapt to any change in the system, such as for example adding, deleting and/or changing the order of parameters of a method, introducing new methods to access some other data, or changes in the underlying schema or data in the Triples Store. Additionally, the querying mechanism allows specification of constraints and complex relationships among parameters as well as filtering and ordering of results etc.—features which are usually not available with ordinary method invocation.

The semantic web application server 314 comprises one or more semantics-based dynamic and autonomic meeting applications 316 such as for example a meeting scheduler and a meeting management dashboard. Each semantics-based dynamic and autonomic meeting applications 316 queries information from the knowledge server 328 to perform meeting related tasks (eg., scheduling a meeting, reserving meeting resources), and display results to users at the user interface 306.

In one embodiment, one or more semantics-based dynamic and autonomic meeting applications 316 query meeting related data (eg. locations, and/or time zones) from the semantic web services/data 308 via the Internet (such as for example DBPedia and geonames) by using an appropriate triples query language such as for example SPARQL. If needed, the semantics-based dynamic and autonomic meeting applications 316 may also update the content of the semantic web services/data 308.

The semantics-based dynamic and autonomic meeting application 316 contains a specialized triples store 324, description logic axioms for applications 322, algorithmic logic 318 and rules logic 326. Depending on its functionality, the semantics-based dynamic and autonomic meeting application 316 (eg., the meeting scheduler application) may also contain a learning engine 320. The semantics-based dynamic and autonomic meeting application 316 uses a concepts-based data subsetting method to improve its scalability by reducing the time to reason over data. With this method, the dynamic and autonomic meeting application 316 retrieves a subset of triples that are directly related to its functionality from the triples store 334 in the knowledge server 328, and stores the retrieved triples in the specialized triples store 324. Because tightly related concepts are defined in the same ontology, and ontologies are stored in the triples store 334 using named graphs, retrieving triples related to a meeting application 316 is easy and fast. Reasoning over the data in the specialized triples store 324 is faster than reasoning over the data in the triples store 334 because the specialized triples store 324 only contains a subset of triples.

The description logic axioms for application 322 stores axioms specific to the application 316 that can be used to infer implicit information from the data stored in the specialized triple store 324 and detect discrepancies and contradictions in data.

Data stored in the specialized triple store 324 is processed by the application logic. The application logic is partitioned into an algorithmic logic module 318 and a rules logic module 326. The logic that does not change over time and is common over the organization is partitioned into the algorithmic logic 318, which is coded into the meeting application 316 as algorithms. On the other hand, the logic that may vary over time or organizations is partitioned into the rules logic 326, which is expressed in terms of description logic rules using a rules description language such as SWRL. This logic partitioning enables higher performance and scalability because the time required for rules reasoning is reduced as a consequence of the coding of common logic into the meeting application 316. Logic partitioning also keeps the meeting application 316 highly flexible and evolvable because description logic rules (as rules logic 326) can be changed at runtime as required, and recompiling or redeploying of the meeting application 316 is not required to adapt the system accordingly.

The learning engine 320 autonomously and dynamically adapts the behavior of the meeting application 316 by learning patterns in the data recorded from various sources to form description logic rules. The sources of data include application usage patterns, and data from the knowledge acquisition layer. This dynamic adaptation results in, for example, a better user experience and a more efficient system.

A set of machine learning classifiers (eg., classifiers using decision trees, neural networks, nearest neighbor algorithms, etc.) are used in the learning engine 320 to observe patterns and learn on the acquired data. The learned knowledge is then transformed into description logic rules which are added to the rules logic 326. For example, if a decision tree is used as a classifier, a leaf of the tree becomes a consequent of a description logic rule while all the segments in the tree from the root to that leaf becomes the antecedents joined by the logical AND. Since the learned knowledge is combined with the application logic in the form of rules, in most cases this will make the application more efficient by eliminating superfluous calls to a separate learning component. Description logic rules are editable and hence it is also possible to override learner's assessments.

To facilitate the interaction of different applications in the system, one or more directory facilitators 304 in the directory server 302 register all running dynamic and autonomic meeting applications 316 so that an application can query the directory facilitator 304 to know which semantics-based applications are running and what services they provide. The directory facilitators 304 also register other semantics-based applications 310 that provide services to other applications in the system.

To register in the directory facilitator 304, each of the dynamic and autonomic meeting applications 316 and other semantics-based applications 310 contains a description of its services written by using the Web Ontology Language for Services (OWL/S) and Web Service Definition Language (WSDL) 312. When an application is launched, it registers its services with the directory facilitator 316 by sending its description thereto. The directory facilitator 316 then stores the description in its registry. If an application does not provide any service to be used by other applications it merely queries the directory facilitator 304 in order to use services from other applications. An application is not required to describe its services using OWL/S and WSDL, and is not required to register its services in the directory facilitator 304.

During its execution, each of the registered applications must re-register its services with the directory facilitator 316 at least every T seconds, for example, 30 seconds, which may also be set to a different value by the system administrator. If an application has failed to re-register its services within T seconds from its last (re)registration, the directory facilitator 316 would mark the application as NotRunning in its registry. Such a re-registration mechanism significantly reduces the occurrence of the problem that, when an application abnormally terminated without un-registering its services, a call or a message transferring to the application would fail.

Four types of registration messages are used between semantics-based applications and directory facilitators. When a semantics-based application starts its first-time running, or has been updated, it sends to the directory facilitator a RequestToRegister message that contains its description, or alternatively, contains a link to its description file. The directory facilitator will then copy the application's description to its local storage, register the application and mark the application as Running in the registry. When a semantics-based application stops running, it sends to the directory facilitator a StopRunning message. The directory facilitator will then mark the application as NotRunning in the registry. When a semantics-based application starts its running again or needs to re-register itself, it sends to the directory facilitator a StartRunning message. Then directory facilitator will then mark the application as Running in the registry. If an application is uninstalled from the system, it will send to the directory facilitator a RequestToUninstall message during the uninstallation. The directory facilitator will then delete the application's description from the local storage, and delete the entry of the application from the registry.

The directory facilitator 316 allows applications to dynamically discover available services and adapt their behavior accordingly, which enables a highly integrated environment where different applications work together to enhance workflows. To discover which application provides a required service, an application sends a query to the directory facilitator 304. The directory facilitator 304 looks up the service in its registry. If it finds the service, the directory facilitator 304 replies to the application that sent the query with a XML-formatted message containing the service ID, the name of the application that provides the service and other necessary information such as for example the method the service provides, the name and types of the parameters, the endpoint address of the service, the protocol it supports. Alternatively, the directory facilitator 304 may reply the application that sent the query with a reference to a WSDL document that describes the service. The application that sent the query then inspects the WSDL document to find how to invoke the service. If the requested service is not available, the directory facilitator 304 replies the application that sent the query with a “ServiceNotFound” message. In a preferred embodiment, the “ServiceNotFound” message is an XML-formatted message with empty results field, as shown in FIG. 5c.

According to the present embodiment, users use the meeting scheduler running on the semantic web application server 314 to schedule meetings. In a preferred embodiment, the meeting management system 10 is integrated with Microsoft® Exchange Server®, and provides a browser based user interface (UI) to users. The user starts the meeting scheduler by entering the address of the meeting scheduler into the web browser. When the meeting scheduler UI is started, it automatically logs the user into the meeting scheduler by using the authentication information obtained from the Windows domain server using NT LAN Manager (NTLM) protocol, if the user is in the organization's internal network. If the user is outside of the organization's internal network, a login dialog window will be displayed, and the user must enter the user name and password to login.

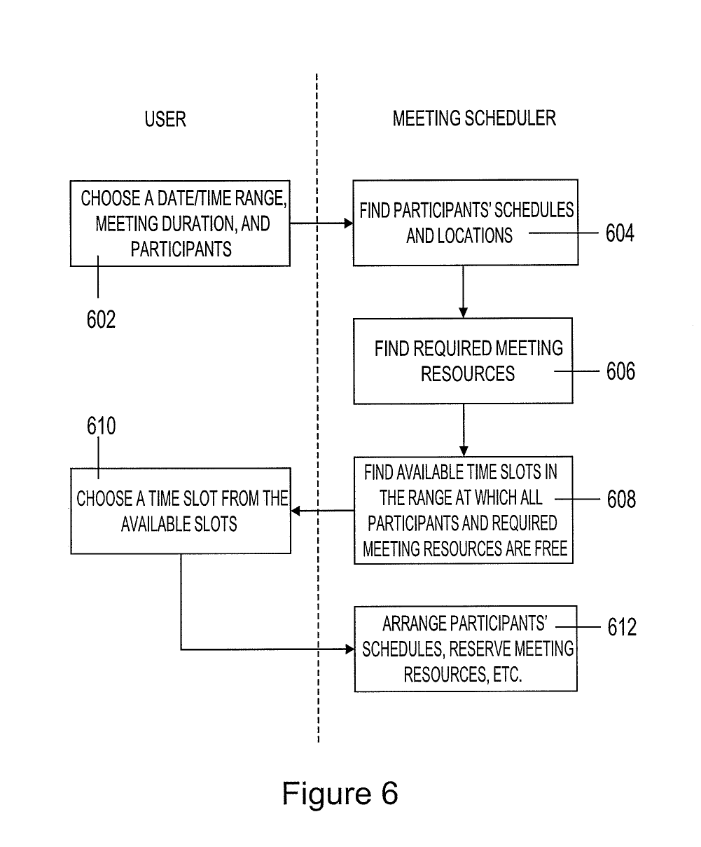

In a present embodiment, the meeting scheduler greatly reduces the steps and settings the user needs to perform for arranging a meeting, as compared with standard meeting schedulers currently known. FIG. 6 shows the workflow of the user and the meeting scheduler. At step 602, the user chooses a preferred range of meeting date/time, the meeting duration and the meeting participants. The meeting scheduler then automatically finds the participants' schedules and their locations (step 604). According to participants' locations, the meeting scheduler finds meeting resources that may be required for the meeting, eg., meeting rooms, audio/video devices, and voice bridges if participants are not at the same location (step 606). At step 608, the meeting scheduler find all feasible time slots from the range the user chooses at which all participants and required meeting resources are free. The user then reviews the feasible time slots and selects one (step 610). Based on the user's selection, the meeting scheduler arranges participants' schedules and reserves meeting resources (step 612) to set up the meeting. The meeting scheduler may also perform other tasks for setting up the meeting, such as for example, sending out notifications to each participant, scheduling a remote conference session on the conference server and sending the name and password of the remote conference session to the user who creates the meeting and all remote users.

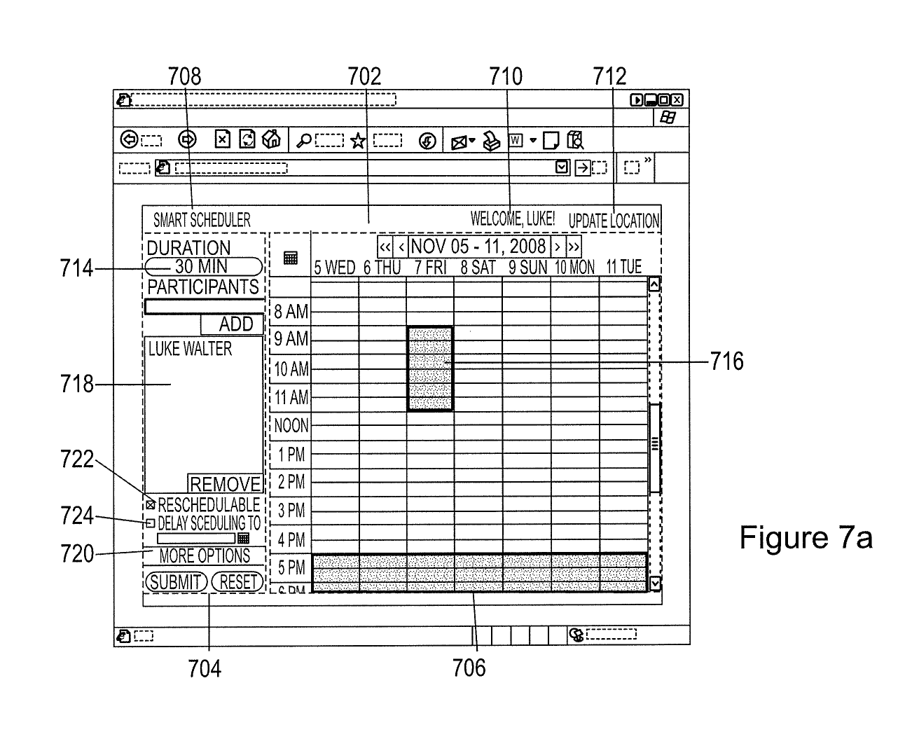

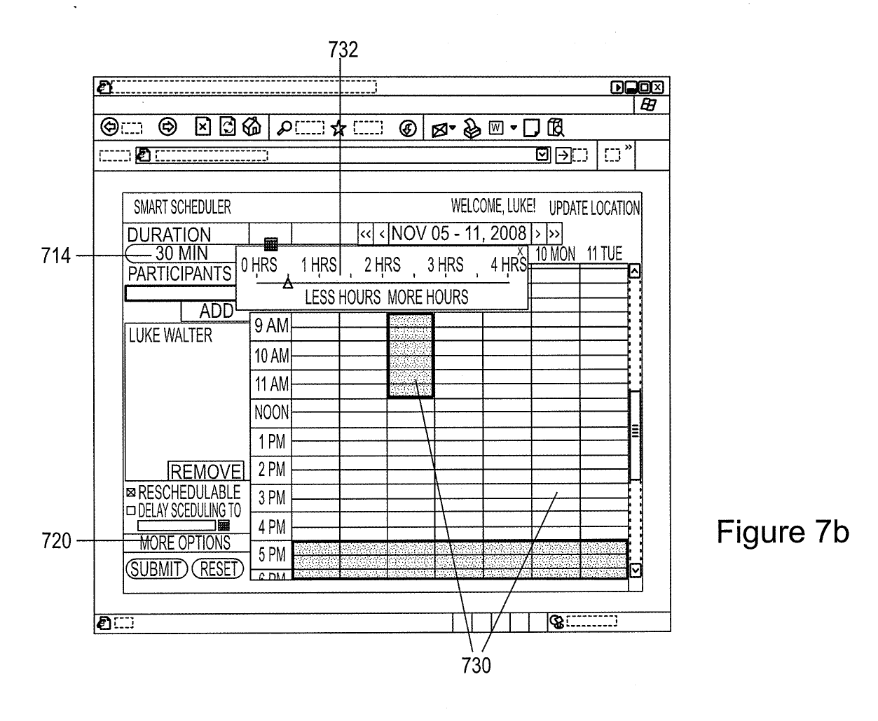

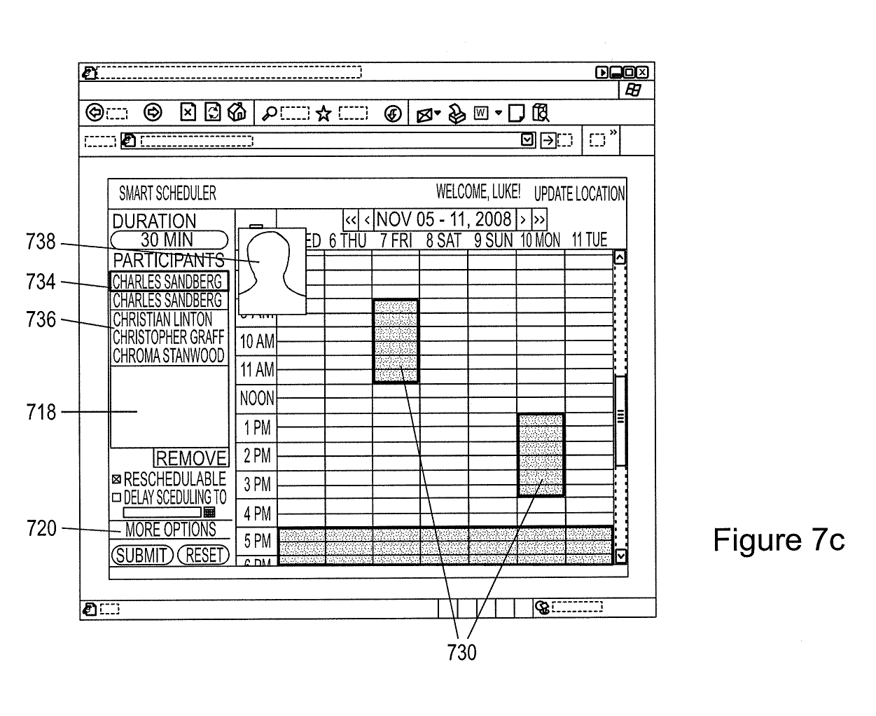

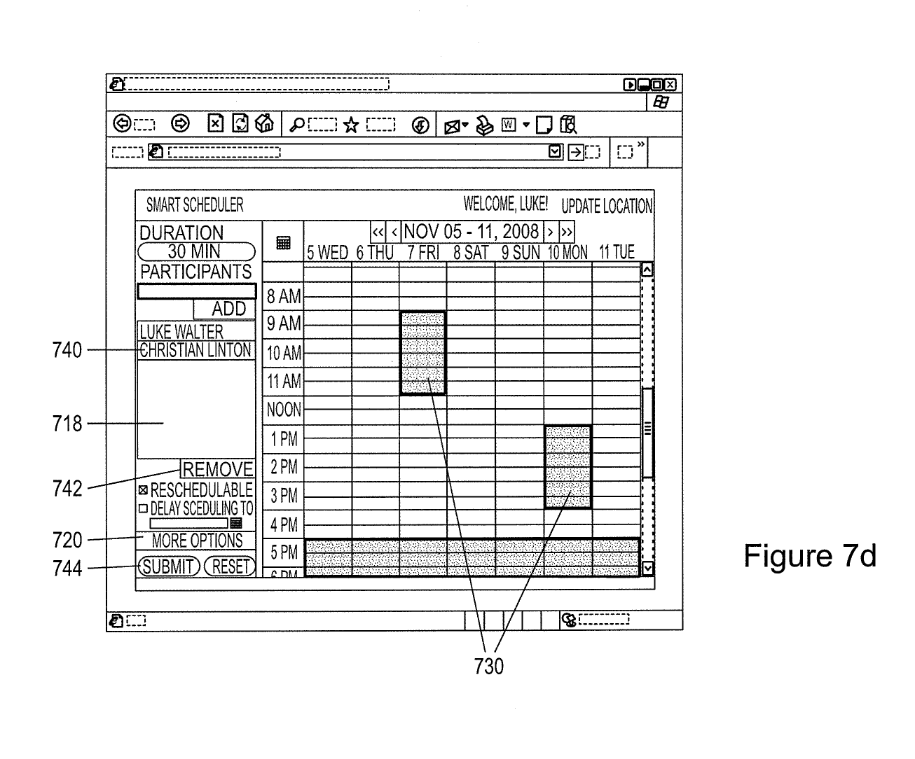

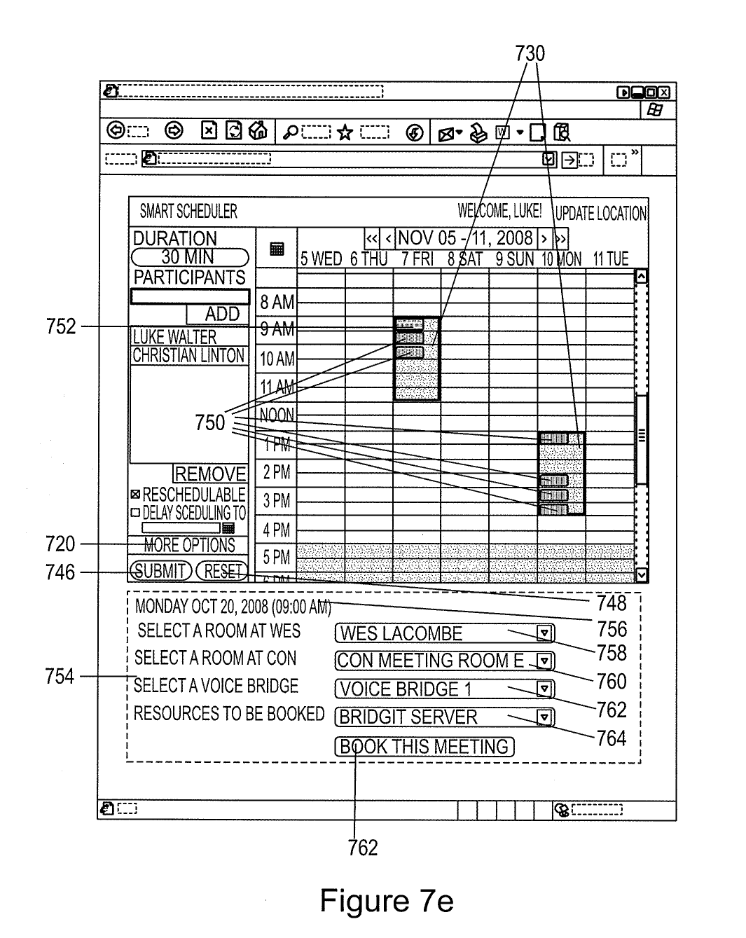

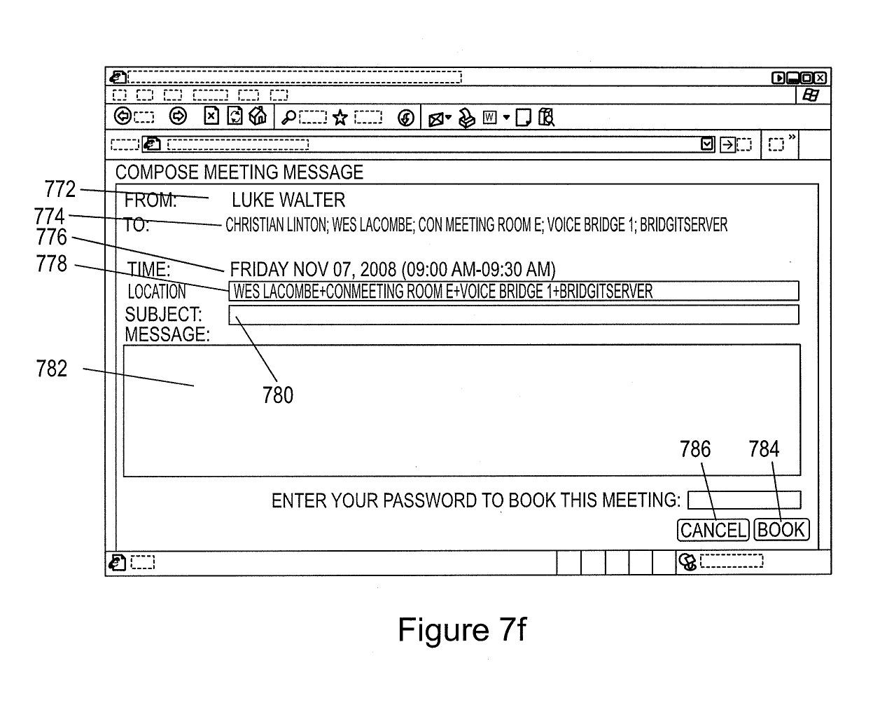

FIGS. 7a-7f illustrate the meeting scheduler user interface. As shown in FIG. 7a, the user interface is partitioned into three parts, including a title bar 702, a left window 704 and a calendar window 706. The title bar 702 comprises the program title 708, a greeting area 710 showing the user's name, and a link 712 for updating the user's location. The calendar window 706 is used to display the date and time of scheduled meetings of the user, and for the user to select a date/time range to set up meetings. The left window 704 is used for setting up other meeting parameters including the meeting duration, meeting participants and other meeting options.

The user's name is automatically added to the participant list 718 by default. The semantics-based meeting management system uses machine learning algorithms to learn the preferences of the user. Based on the user's historical meeting scheduling activity, the meeting scheduler automatically sets up default values that best match the user's preference. In the example shown in FIG. 7a, the default meeting duration 714 is set to 30 minutes, and the preferred date/time range 716 is set to Friday from 9:00 am to 12:00 pm. The default values are different from user to user, and are different from time to time according to each user's preference. For example, according to a user's preference, the default preferred date/time range 716 is set to 1:00 pm to 5:00 pm if he logs in the system in the morning, and is set to 9:00 am to 12:00 am of the next day if he logs in the system in the afternoon.

If the user wants to change the date/time range, he may double-click on the selected date/time range 716 to delete it, and then drag the cursor inside the calendar window 706 to specify another date/time range 730 (see FIG. 7b). The date/time range may be continuous or discontinuous blocks of time.

The user may click the meeting duration button 714 to change the meeting duration. A pop-up window 732 is shown to let the user specify a meeting duration.

As shown in FIG. 7c, the user types in a person's name in the input box 734 to add a person to the participant list 718. While the user is typing in the name, the meeting scheduler automatically displays a name list 736 that matches the letters typed in the input box 734, and automatically completes the name in the input box 734 to match the first name in the name list 736. The person's photo is also shown in a pop-up window 738. The photo 738 changes while the user navigates to other names in the name list 736 by using the keyboard. The user may add a person in the name list 736 to the participant 718 by navigating to the person's name and pressing the Enter key on the keyboard, or by clicking on the person's name. The user may also add people external to the organization into the participant list 718.

Referring to FIG. 7d, if needed, the user may click on a person's name 740 in the participant list 718 and then click the Remove button 742 to remove a name from the participant list 718.

After setting up the preferred date/time range, the meeting duration and the participants, the user clicks the Submit button 744 to instruct the meeting scheduler to arrange a meeting.

FIG. 7e illustrates the result after clicking the Submit button 744. The Submit button now becomes the Resubmit button 746. The time slots 750 and 752 at which all participants and meeting resources are free are marked as feasible. In a preferred embodiment, a rule is applied to the meeting scheduler such that lunch hours and holidays are excluded from any feasible time slots.

According to the user's preference pattern the semantics-based meeting management system has learned, the feasible time slot 752 that best matches the user's preference is selected as the default choice and marked with a dark color. Its detail is shown in the detail area 754. The user may click on another feasible time slot to see the detail associated therewith. The time slot that the user clicks is then marked with a dark color to indicate that it is the current selected time slot.

As shown in FIG. 7e, the starting time of the currently selected feasible time slot 752 is shown at the area 756. Because the meeting scheduler detects that the meeting participants are at two different locations: Wes and Con, it automatically checks the availability of meeting resources, eg., the meeting rooms at each location, the voice bridge and the data communication server. The available meeting rooms at Wes are listed in the drop-down menu 758, the available meeting rooms at Con are listed in the drop-down menu 760. Similarly, the available voice bridges to be used between Wes and Con are listed in the drop-down menu 762, and the conference servers required to establish data connection between computers in Wes and Con are listed in the drop-down menu 764.

The default options are those shown on the fields 758-764 before the user makes any selection. For example, the default meeting room at Wes for the selected feasible time slot 752 is Wes Lacombe, and the default meeting room at Con is Con Meeting Room E. The default options are determined by the meeting scheduler according to participants' preference patterns, participants' physical locations, and/or and scheduled time for the meeting. For example, if the user is scheduling a meeting in 15 minutes, a meeting room (of appropriate size) closer to the participants' physical locations would be selected as the default.

The default choices of the meeting resources are provided as recommended choices to maximize the autonomy of meeting scheduling, so that the user may set up the meeting by simply clicking the “Book This Meeting” button 762. Optionally, the user may click on buttons 758-764 to make his own selections. If, for example, all participants will come to the location Con and the user does not need to book any room in Wes, he can click the button 758 and select the option “None” from the pop-up menu. After selecting the meeting date/time and the meeting resources, the user clicks the button 762 to establish the meeting schedule. The meeting scheduler then updates all participants' schedules, and reserves the booked meeting resources at the requested date/time.

If the user wants to change the participant list, meeting duration and/or location, and find feasible time slots again, he can make the changes and then click the Resubmit button 746. The meeting scheduler will search for feasible time slots based on the changed user requirements. If the user wants to re-designate a preferred date/time range, he can click the Reset button. The Resubmit button 746 then becomes the Submit button, and all preferred date/time range that the user selected, as well as all feasible time slots the meeting scheduler found, are cleared so that the user can re-designate the preferred date/time range.

After making a decision on the meeting detail, the user presses the Book This Meeting button 762. As shown in FIG. 7f, an email window appears to allow the user to write a message (using pen input, keyboard input, etc). The From 772, To 774, Time 776 and Location 778 are automatically filled in by the meeting scheduler. The user can specify the Subject 780 and the message detail 782. After the user clicks the Book button 784, the meeting scheduler will set up the meeting by sending the email to all participants, meeting rooms and resources, revising participants' schedules and reserving meeting rooms and resources. The user may also click the Cancel button 786 to go back to the meeting detail page (See FIG. 7e) to adjust the detail.

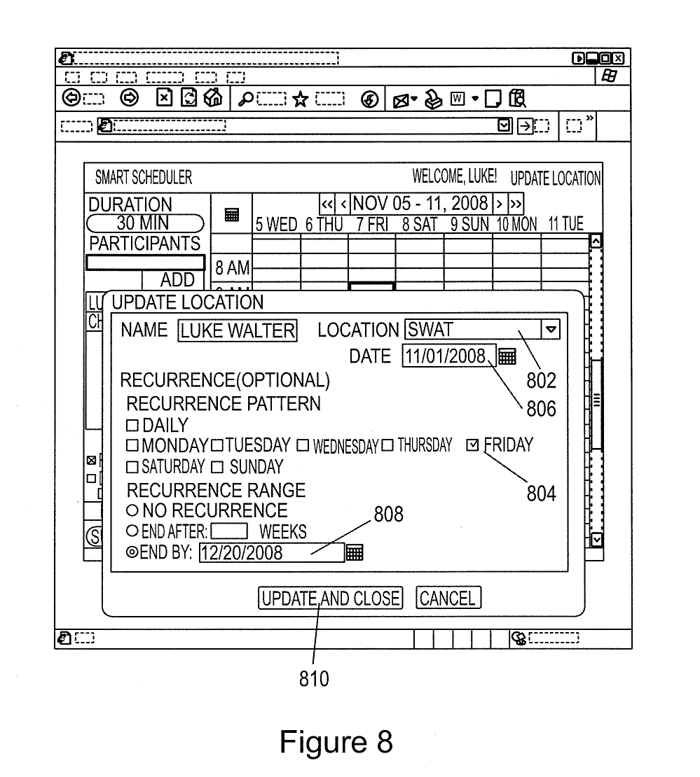

As illustrated in FIG. 8, the user may also specify a temporary location that he will be in a period of time. For example, although his regular location is Con, the user may specify that he will be at the location SWAT 802 every Friday 804 from a first date 806 to a second date 808. After the user clicks the Update and Close button 810, the meeting scheduler will update the user's profile and reschedule all meetings that the user involves to reflect the change. The rescheduling may involve finding a new feasible time slot, scheduling the meeting at the new feasible time slot and releasing the old time slot, rearranging participants' schedules, and/or reserving new and canceling old meeting rooms, voice bridge(s), data conference session(s) and/or other meeting resources. Notifications of the rescheduled meetings may also be sent to all participants, meeting rooms and meeting resources.

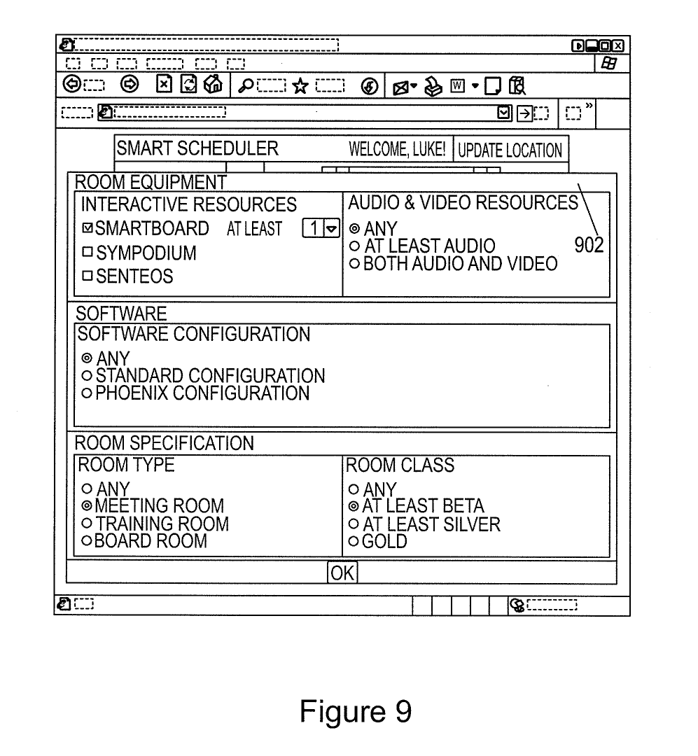

Usually, the meeting scheduler automatically selects meeting resources for users based on users' preferences. However, the user may also specify detailed requirement by clicking the More Options button 720 (see FIG. 7a). As illustrated in FIG. 9, a dialog 902 pops-up so that the user can specify the detail of his requirement. The meeting scheduler remembers the user's selection, and will use it as the default selection in the user's future meeting scheduling.

Based on the semantic framework and machine learning used in the meeting management system, the meeting scheduler optimizes meeting schedules in accordance with the rules set in the meeting management system and the learned pattern of user preference.

For example, the meeting management system detects a user's location by using a plurality of methods. It obtains user location data from the LDAP Server and using it as the regular location for the user. As described above, it also allows the user set up temporary location change via the meeting scheduler UI. If a user equips an RFID tag, the sensor 346 in the knowledge acquisition layer 338 detects the user's current location and provides that information to the meeting management system to update the user's information. Other methods of detecting a user's location may also be used. The meeting management system then uses machine learning to find the pattern of the user's location change. When the user schedules a meeting, the meeting scheduler will use the learned pattern to set up the user's location in the date/time range the user specified unless the user has explicitly specified the location at the date/time.

For example, it may be the case that the meeting management system finds that user A, whose regular location is at Con, is always at Wes on every Friday. On a Thursday morning, the system detects from the user's RFID tag that user A is at SWAT, when user A wants to schedule a meeting in the afternoon or in the morning of the next day (Friday). The meeting scheduler first uses a threshold (eg., before the end of the day) to determine the user's location. For the user's preferred time range that is within the threshold, eg., the preferred time range in Thursday afternoon, the meeting scheduler uses SWAT as the user's location. For the user's preferred time range that is beyond the threshold, eg., the preferred time range in Friday morning, the meeting scheduler retrieves the user's location pattern (at Wes on every Friday) and use Wes as the user's location. The meeting scheduler then find feasible time slots in the user's preferred time range using the above location information. As a result, if the user selects a feasible time slot on Thursday afternoon, the meeting will be held in SWAT; if the user selects a feasible time slot on Friday morning, the meeting will be held in Wes.

The meeting scheduler uses intelligent matchmaking to arrange time, meeting rooms and other meeting resources to maximize the usage of meeting facilities and the efficiency of users' time while satisfying users requirement.

For example, when scheduling a meeting, of all meeting rooms that satisfy the user's requirement, the meeting scheduler preferably selects the smallest room or the room with minimum required meeting resources as the default option. The meeting scheduler also selects a time slot for the smallest continuous span of feasible time (the feasible time between two scheduled meetings) as the default meeting time. By leaving large meeting room or meeting room with more facilities and large continuous piece of feasible time to future meeting scheduling requests, the probability of finding a feasible schedule for a future meeting is then increased. Optionally, the importance of the participants (such as CEO, VPs, etc) could be used to determine the facilities selected. For example, meetings of the Board of Directors may preferentially be scheduled in the Board Room.

Sometimes, a feasible schedule for a new meeting can only be found by rescheduling other meetings. In this case, the meeting scheduler automatically reschedules some scheduled meetings to find a feasible time for the new meeting while ensuring that all requirements of the meetings being rescheduled, including the preferred date/time range, are still met. Policies can be defined at departmental/organizational level to define default setting, for example, the meetings of which departments are re-schedulable by default, and those of which are not. The meeting scheduler also provides a checkbox 722 (see FIG. 7a) which, by default, is set to checked if the default setting is re-schedulable, or unchecked if the default setting is not-re-schedulable. Users may change the state of the checkbox 722 to override the default setting. The meeting scheduler also learns the user's preference to set up the default value of this option for the user.

In one embodiment, the rescheduling only occurs when it is required. Notifications are sent to all users involved in the rescheduling. In another embodiment, the rescheduling is proactive. When a re-schedulable meeting request is submitted, the meeting scheduler will not ask the user to select a meeting time slot. Instead, it will automatically find a time slot for the user within the preferred date/time range so that the probability of finding a feasible schedule for a future meeting is maximized while the meeting requirements specified by the user are met.

With proactive rescheduling, the meeting scheduler first finds all feasible time slots within the preferred date/time range. Then, the meeting scheduler selects a time slot to book the meeting from the feasible time slots based on some optimization criteria. In a preferred embodiment, the meeting scheduler divides each day into a plurality of meeting-scheduling time pieces (eg., 15 minutes per meeting-scheduling time piece), where a meeting consists of an integer number of meeting-scheduling time pieces. For each object (eg., a person, meeting room or resource), the meeting scheduler counts the number of times, denoted as B, that a meeting-scheduling time piece (e.g., 9:00 am to 9:15 am) was occupied in a historical time window (eg., in the last month). It also counts the total number of times, denoted as T, the time piece occurred in the historical time window. Then, it calculates the busy rate for the object at the time piece as

Busy Rate=B/T.

For proactive meeting rescheduling, the meeting scheduler calculates the busy rate for each feasible time slot by first averaging the busy rate of all participants, meeting rooms and resources at each time piece of the time slot, and then averaging the busy rate of all time pieces in the time slot to obtain the average busy rate of the time slot. After obtaining the average busy rate of each time slot, the meeting scheduler selects the time slot with the lowest busy rate and moves this meeting.

In another embodiment, the meeting management system assigns different weights to objects, where the one with higher priority is assigned with a higher weight. Then, the busy rate of an object is adjusted (eg., multiplied) by the corresponding weight before calculating any average busy rate.

In yet another embodiment, the meeting scheduler does not use busy rate. It selects a time slot for setting up the meeting such that, among the objects involved in the meeting, the continuous time piece of the one having the highest weight available for a future meeting is maximized.

In still another embodiment, the meeting scheduler simply selects a time slot in the smallest continuous piece of feasible time for booking the meeting. Those skilled in the art will appreciate that other optimization criteria for proactive meeting scheduling are also possible.

In some cases, the user only has a loose requirement for the meeting time. For example, a team may need to meet on every Wednesday at any available time. Thus, the exact meeting time is not important and can vary from time to time as long as the meeting is scheduled for every Wednesday. However, the exact meeting time must be scheduled and all team members must be notified by, eg., every Tuesday afternoon for the next meeting. In one embodiment, the meeting scheduler takes these cases into consideration, and provides users an option 724 (see FIG. 7a) for delayed scheduling to optimize the meeting scheduling performance. When using delayed scheduling, the user checks the checkbox in the option 724 and designates a deadline by which the meeting scheduler must decide and notify the user where and when the meeting is scheduled. After the user submits the meeting request as described before, the meeting scheduler does not immediately provide the user any detail for the meeting schedule. Instead, it stores the delayed-scheduling meeting request in a cache, and optimizes all tentative schedules when the deadline of a delayed-scheduling meeting request comes.

The meeting scheduler preferably has a feature adjustable granularity that not only allows scheduling of meetings as a whole but also allows scheduling of activities within a meeting. This feature is useful in scenarios where different activities require different resources/attendees. For example, it may be that user B has a meeting M1 from 9:00 am to 12:00 am, but in particular she will only be required for a discussion D1 during that meeting that is itself scheduled for 9:00 am-9:30 am, according to the meeting agenda. The meeting scheduler obtains the meeting agenda from the agenda file stored on the server by using the software agent 348. If user B also needs to have another meeting M2 from 9:00 am to 10:00 am, the meeting scheduler automatically adjusts the meeting agenda by moving the discussion D1 that user B is to be involved with from 9:00 am-9:30 am to 11:00 am-11:30 am. Accordingly, the activity D2 originally scheduled at 11:00 am-11:30 am is moved to 9:00 am-9:30 am. As such, user B can attend the meeting M2 at 9:00 am-9:30 am, and then join the meeting M1 so as to attend the discussion D1 from 11:00 am-11:30 am.

In cases when a meeting has been scheduled, but a required participant is unable to attend for some reason, the meeting scheduler automatically detects the information by, eg., obtaining update of user schedules from Microsoft® Exchange Server®, by monitoring and analyzing emails between users and/or by detecting the user's location from his/her RFID tag. The meeting scheduler then revises the meeting schedule according to the information it detects, revises the reservation of meeting resources, and notifies all meeting participants.

In practice, the actual meeting duration is often different from the scheduled duration, and is often difficult to estimate before the meeting starts. When the actual meeting duration is shorter than scheduled, the usage of meeting resources decreases. On the other hand, when a meeting lasts longer than scheduled, it might be the case that subsequent meetings will have to be delayed, or the meeting will have to be abnormally terminated at the scheduled end time. Furthermore, rescheduling of the remainder of the terminated meeting may need to occur. The meeting scheduler intelligently handles this uncertainty by learning the patterns of meetings using machine learning algorithms. For example, the meeting scheduler learns that a meeting organized by user A with the team T often lasts for about 30 minutes longer than scheduled. When user A schedules a meeting with the team T, the meeting scheduler will automatically add 30 minutes to the meeting duration requested by user A, and then find feasible time slots. It will then prompt user A that the feasible time slots are found based on a 30-minute longer duration because the meeting he scheduled in the past often last 30 minutes longer than what he scheduled, and suggests he use the recommended meeting duration. Alternatively, the meeting scheduler may automatically book the meeting with the 30-minute longer duration without asking user A for confirmation.

As another example, the meeting scheduler may learn that a meeting organized by user B with the team Y often lasts for about 30 minutes shorter than scheduled. When user B schedules a meeting with the team Y, the meeting scheduler will automatically deduct 30 minutes from the meeting duration requested by user B, and then find feasible time slots. It will then prompt user B that the feasible time slots are found based on a 30-minute shorter duration because the meetings she scheduled in the past often last 30 minutes shorter than what she scheduled, and suggests she use the recommended meeting duration. Alternatively, the meeting scheduler may automatically book the meeting with the 30-minute shorter duration without asking user B for confirmation.

The meeting scheduler is integrated with a plurality of other meeting management applications, and shares with them a coherent knowledge source. As a result, information at one of the applications is automatically propagated to other relevant applications. The applications automatically take required actions without a user's intervention. The integration of the meeting scheduler and other meeting management applications prevents tedious and iterative task of manually propagating information from one application to another. For example, when a user submits a sick day request via the organization's workflow processor, the workflow processor will automatically propagate the information to the meeting scheduler, and the meeting scheduler will then reschedule all meetings that are affected by the user's sick day off. The participants of the rescheduled meetings will be automatically notified. Optionally, the meeting organizer could receive a notification that one of the attendees is ill and whether or not that attendee is necessary at the meeting. If the organizer indicates that the attendee is not necessary, the meeting will not be rescheduled.

The meeting scheduler supports sending instant meeting schedule updates to handheld devices. Moreover, it updates meeting scheduling information in real-time. For example, if a meeting participant P finds that he will be late or cannot attend a meeting, he can send a notification message from his handheld device to the meeting management system. If the time between the system receiving the notification message and the meeting starting is longer than a threshold (eg., 4 hours), the system reschedules the meeting and notifies all participants. If the time between the system receiving the notification message and the meeting starting is less than a threshold, or the meeting has started when the system receives the message, the system may reorganize the meeting agenda by moving the topics that the meeting participant P is involved with to a later time to allow the participant P to catch up with his topic. The system will notify all participants of the change of meeting schedule and/or agenda via email and/or message to participants' handheld devices.

As previously mentioned, the rules used by the meeting management system may be easily changed by the system administrator without recompiling or redeploying the meeting management system. For example, when the meeting scheduler arranges a meeting, the meeting rooms of which the capacity (the number of seats) is less than the number of participants are excluded from the available resources according to the following rule:
(?x rdf:type sm:Meeting)(?z rdf:type sm:MeetingRoom)(?z sm:seatingCapacity ?a)(?x sm:hasNumberOfAttendees ?b) lessThan(?a ?b)->(?z sm:notACandidateFor ?x)
   However, the system administrator may delete this rule such that the rooms that do not have enough capacity will also be listed in the feasible rooms list 758 and/or 760 (see FIG. 7e).

As another example, lunch hours and holidays are excluded from any feasible time slot by default. However, the system administrator may delete this rule so that meetings can be scheduled at lunch hours and/or holidays. The system administrator may also modify the rules such that lunch hours and holidays are excluded from any feasible time slot by default. However, some users may be allowed to override default settings (for example, the CEO of a corporation may wish to schedule meetings outside of the normal parameters).

As yet another example, when the meeting scheduler arranges a meeting, only those time slots when all participants are free will be selected as feasible time slots. However, the system administrator may change the rule such that the time slots at which some optional participants, or participants having low weights, are not available will also be marked as feasible.

The priority hierarchy for objects is also set by corresponding rules. The meeting management system may then establish that, for example, the preferences of a certain group (eg., executives) are always met, and/or certain resources are used as much as possible.

By dynamically adding, deleting, or revising rules by system administrators and/or users with proper access rights, the semantics-based system is highly evolvable, and highly adaptable to policies/requirement change of the organization in real-time without the need of recoding, recompiling or re-deploying a part of or the whole system. The semantics-based system also evolves by automatically inferring additional knowledge.

In the above description, the meeting scheduler simplifies user's operation in scheduling meetings by maintaining a simple UI and automatically managing meeting resources. In an alternative embodiment, the meeting scheduler is integrated into an information kiosk to provide information-rich functions. In this embodiment, the information kiosk is deployed with the meeting scheduler UI that incorporates floor maps to provide users visual clues in scheduling meetings, and other semantics-based information inquiry functions. The information kiosks are installed in the hallway and around the meeting rooms of a building, and, as previously described, the meeting scheduler is running on the semantic web application server. The information kiosks are preferably equipped with touch sensitive screens so that users can easily operate the kiosks by using their fingers and/or styluses.

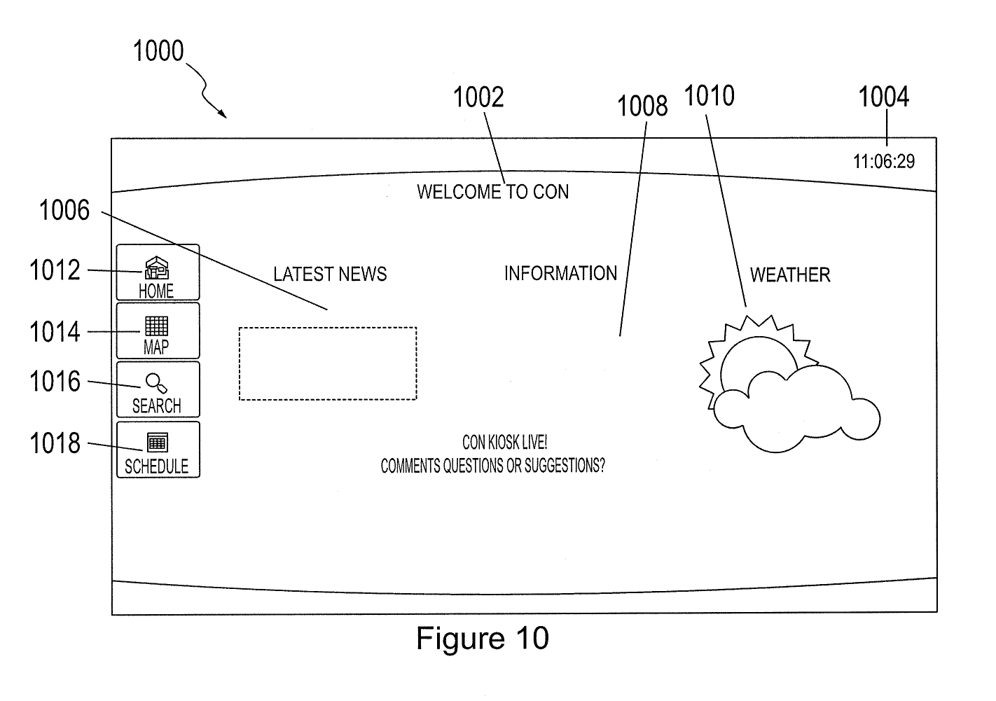

The server-side information kiosk application is run on the semantic web application server 314, and has the same structure as the dynamic and autonomic meeting application 316 described above. The information kiosk UI is deployed in each information kiosk. FIG. 10 illustrates the main screen 1000 of the meeting scheduler UI after the user logs-in, which contains a greeting area 1002 that displays the name of the building, a time area 1004 showing the current time, and a news area 1006 with news items rolling from the bottom to the top of the area 1006. Each news item in news area 1006 contains a link to additional detail. Also displayed is an information area 1008 for providing other information (such as general announcements), a weather area 1010 showing the current weather information, and a plurality of buttons 1012 to 1018 for users to perform information inquiry tasks. The content of the news area 1006, the information area 1008 and the weather area 1010, sent to the information kiosk UI from the server-side information kiosk application, is retrieved from the knowledge server 328, and can be customized by the system administrators or other users with appropriate access rights. The knowledge server 328 collects and updates the content of the news area 1006, the information area 1008 and the weather area 1010 from a number of sites via the Internet that publish RSS feeds. Those skilled in the art will appreciate that other type of information areas may also be used in the information kiosk UI.

The Home button 1012 is used for returning to the main screen from any other screens. The Map button 1014 is used for displaying the floor maps of the building to provide users the visual clue of the location of people and building facilities (eg. meeting rooms). The Search button 1016 is used for searching for a person in the building of a meeting facility (eg. a meeting room) in the building. The Schedule button 1018 is used for scheduling a meeting as described above.

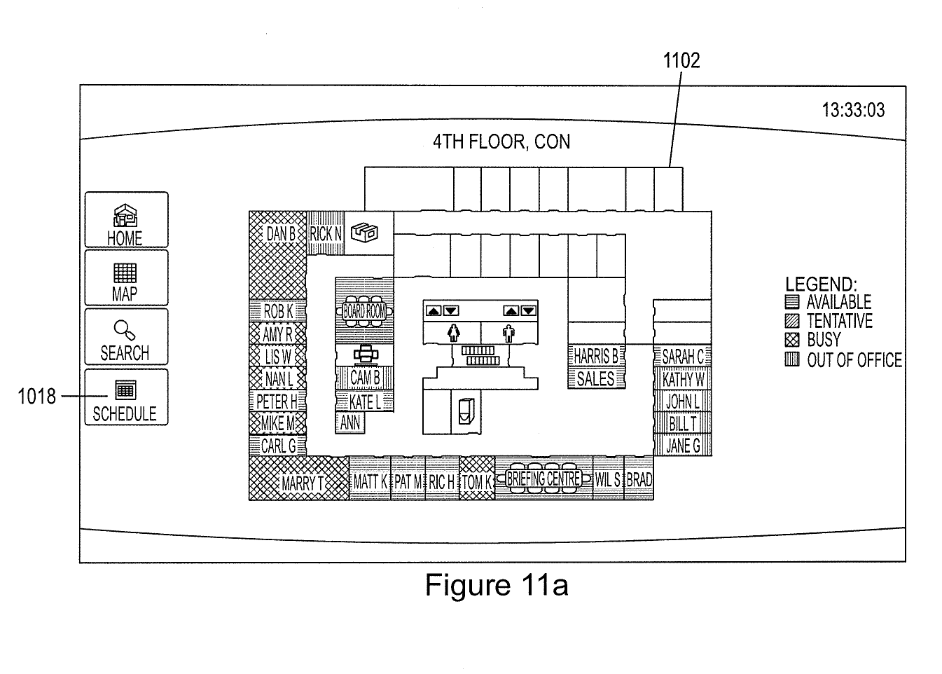

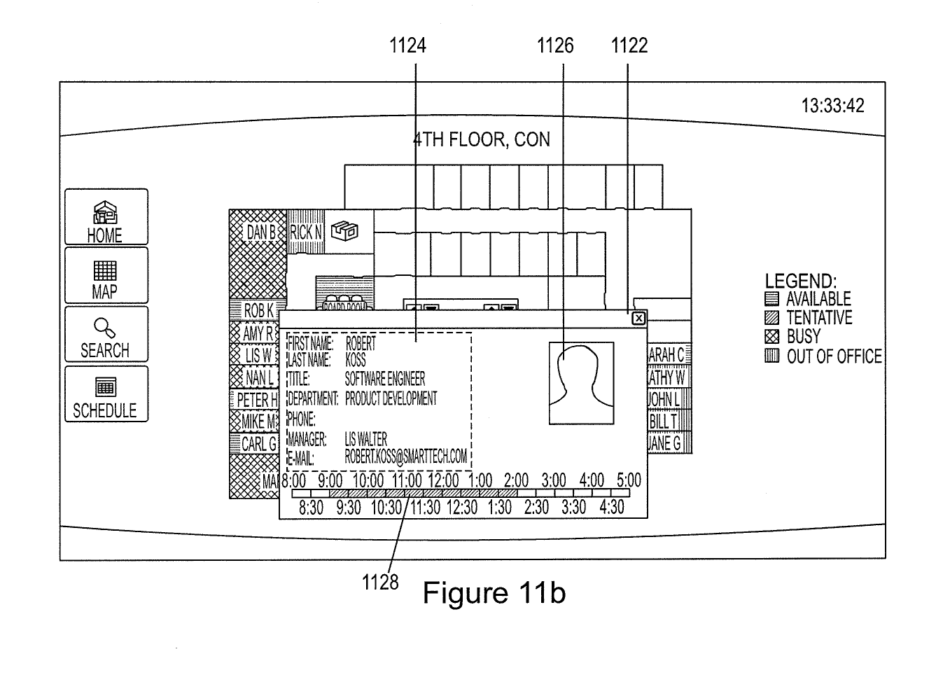

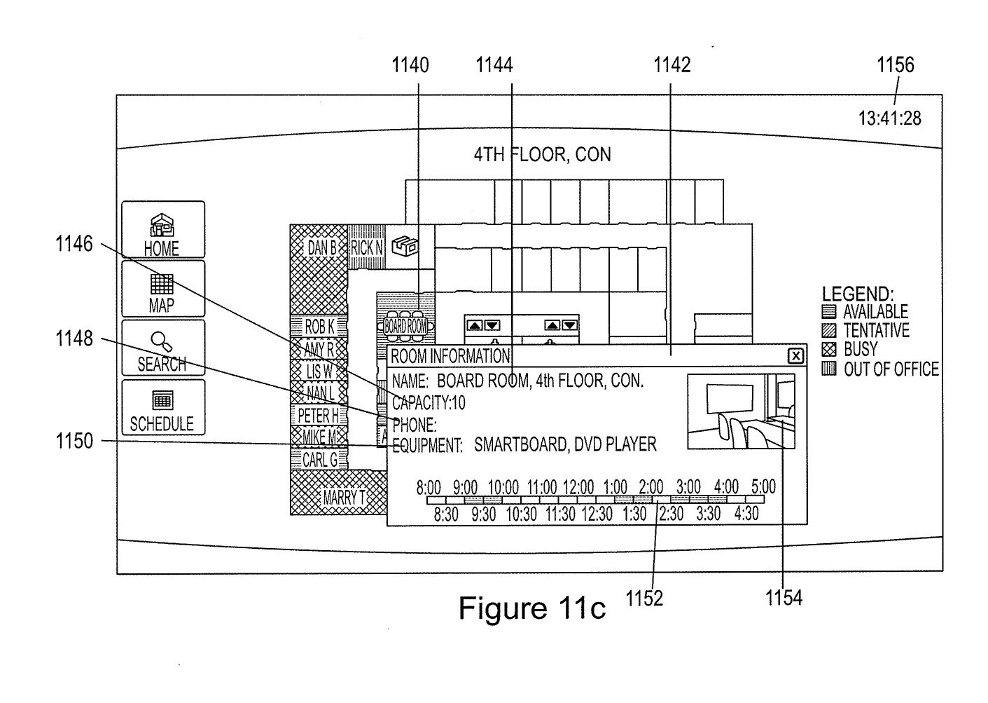

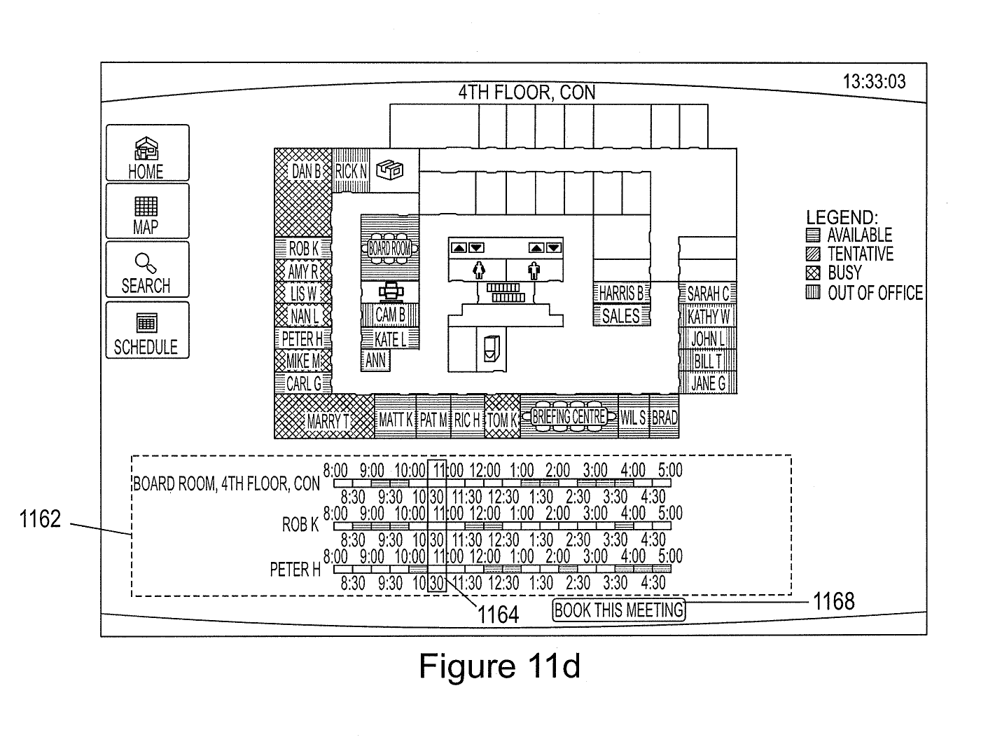

FIG. 11a illustrates the screen after the user clicks the Map button, which shows the map 1102 of the floor where the kiosk is installed. People/meeting room names are marked on the rooms in the map, and the status (eg. available, busy, out of office) of each person and meeting is also clearly marked. Optionally, privacy settings can be implemented so only managers of employees they are managing can be observed when the manager logs-in. As described before, people/meeting room status is obtained from Microsoft® Exchange Server®. Those skilled in the art will appreciate that the status information may also be obtained from other suitable sources.

As illustrated in FIG. 11b, upon clicking on a person's name, a window 1122 pops up to show the person's detailed information such as for example the contact information 1124, photo 1126, and schedule 1128. Other information about the person may also be displayed including, but not limited to, the person's job title, the person's current location, projects the person is responsible for, etc.

As illustrated in FIG. 11c, if the user clicks on a meeting room 1140, a window 1142 pops up showing the detail of the room including the name 1144, capacity 1146, phone number 1148, equipments 1150 (such as interactive whiteboard, etc.) and schedule 1152. Preferably, each meeting room is equipped with a video camera, and the window 1142 displays a real-time photo 1154 captured by the video camera installed in the meeting room.

The real-time photo 1154 provides important information about the meeting room that the user can use to set up temporary meetings. For example, as shown in FIG. 11c, which is a screenshot at 01:41 pm (see 1156), the user needs to have a 30-minute meeting in the meeting room 1140 immediately. Although the room 1140 is booked from 1:00 pm to 2:00 pm according to the schedule 1152, the real-time photo 1154 shows that the room is currently empty, which implies that the meeting from 1:00 pm to 2:00 pm has ended earlier than scheduled. According to the schedule 1152, the next meeting in this room will start at 2:30 pm. Thus, the user may directly occupy this room and start the meeting, or set up a meeting in this room for a temporary meeting starting, say, in 5 minutes and ending before 2:30 pm. Optionally, the camera could be connected to a computer system that is used to detect when all attendees have left the room and notify the meeting scheduler that the room is now available to book or for impromptu meetings.

The user may click the Schedule button 1018 (see FIG. 11a) to set up a meeting with a procedure similar to that described above. Alternatively, if the user wants to set up a meeting with people on the same floor, which frequently happens for a team meeting, the user may simply drag the names of the people he wants to meet with and drop them to the meeting room he wants to use. As shown in FIG. 11d, the schedules 1162 of the selected participants and the meeting room are shown below the map. The user can drag the slide bar 1164 to select a slot of feasible time and click the Book This Meeting button 1168 to set up the meeting.

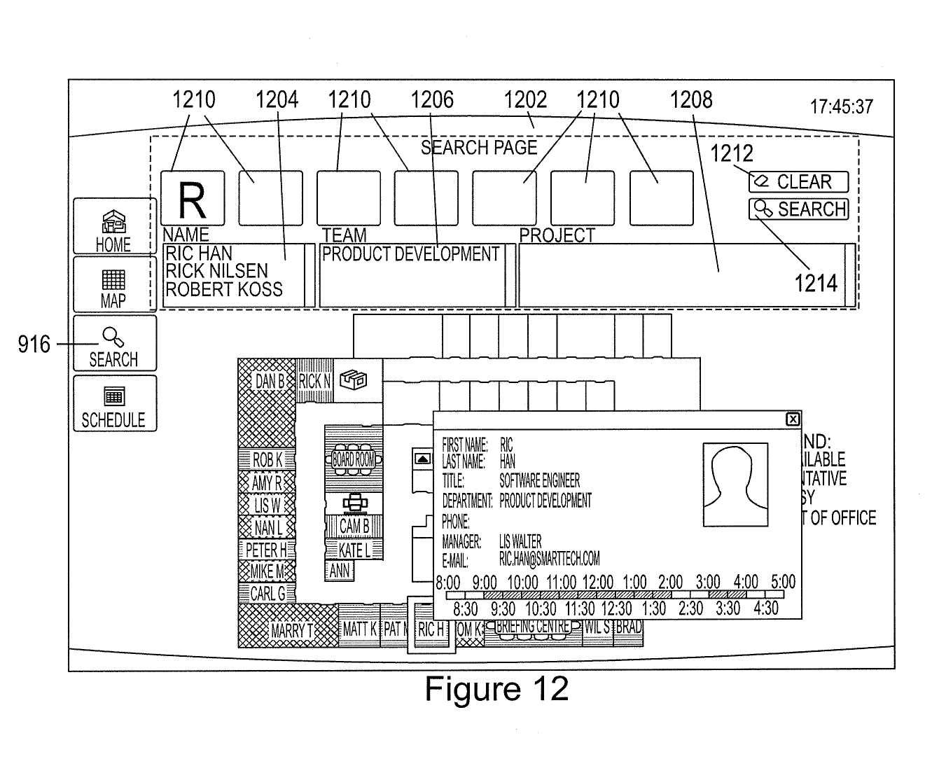

The user may click the Search button 1016 to find a person or a meeting room. As illustrated in FIG. 12, after the user clicks the Search button 1016, a search dialog 1202 appears in the screen for users to search based on various criteria such as name 1204, functional area (team) 1206 and/or project 1208. Other criteria may also be used. The search interface is optimized for touch sensitive display and includes handwriting recognition as a data entry mechanism. The user may touch on a search criterion 1204, 1206 or 1208, and then write on the screen by using a finger or a stylus. The recognized characters are shown in the text boxes 1210. The user may clear the characters in the text boxes 1210 by clicking the Clear button 1212, or click the Search button 1214 to search for the person or the meeting room.

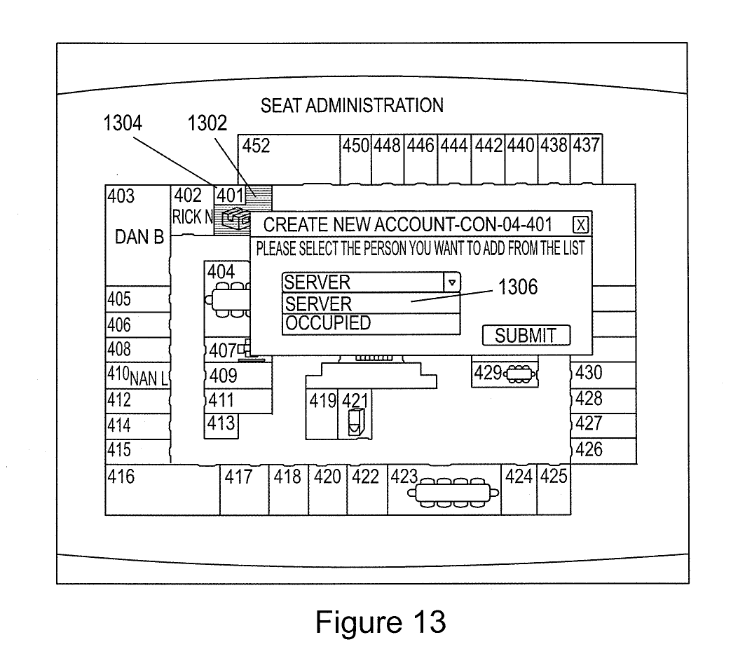

FIG. 13 illustrates the seat administration screen that the administrative users can use to assign offices to people, and assign meeting room names in a quick and intuitive way. Each room is identified by its facility code 1304. The administrative user simply clicks on a room 1302 to pop up the list 1306 of names, and then selects the name to be assigned to the room. The information kiosk application automatically populates the room assignment in the knowledge server 328, which will then populate any information change to relevant applications.

The method described above for scheduling a meeting in an organization environment may be embodied in a software application comprising computer executable instructions executed by computer servers, personal computers, PDA's and/or other suitable information computing devices. The software application may comprise program modules including routines, programs, object components, data structures etc. and may be embodied as computer readable program code stored on a computer readable medium. A computer readable medium is any data storage device that can store data, which can thereafter be read by computer servers, personal computers, PDA's and/or other suitable information computing devices. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion.

Although the semantics-based meeting management system described above is integrated with Microsoft® Outlook®/Exchange Server®, those skilled in the art will appreciate that the system may also be integrated with other email servers, or may be integrated with a semantics-based email server.

In the embodiments described herein, the user must click the “Resubmit” button to recalculate feasible time slots after changing parameters such as for example the participant list, meeting duration and/or location. However, those skilled in the art will appreciate that, at the expense of additional processing power, the meeting scheduler may automatically recalculate feasible time slots immediately after the user changes a parameter.

In the embodiments described herein, emails and instant messaging are used by the system to notify meeting participants, meeting rooms and resources of upcoming meetings. However, those of skill in the art will appreciate that it may also be possible to use other transmission means such as for example, text messaging, voice mail, etc.

In the embodiments described herein, the servers (eg. those described in FIG. 3) are server software. Those skilled in the art will appreciate that these servers may run on the same server computer. Alternatively, some or all of them may run on separate server computers. Although the user interface 306 is implemented as a browser based application in the embodiments described herein, it may also be implemented as a desktop based application. The embodiments described above comply with W3C standards, eg. SWRL is used for describing domain rules, SPARQL is used for queries, and HTTP/SOAP protocols are used for communication between the query endpoint 330 and other semantics-based applications 310. However, those skilled in the art will appreciate that the same techniques may also be implemented by complying other standards or even a developer's own regulations. Also, although domain rules are stored in at least one text file in the embodiments described herein, those skilled in the art will appreciate that other types of date-storing mechanisms (e.g., files and/or databases) may also be used to store domain rules.

In the embodiments described herein, the logic that does not change over time and is common over the organization is partitioned into the algorithmic logic 318. Those skilled in the art will appreciate that, in the situation where the system is deployed in a plurality of organizations (eg., a commercial semantics based information management software sold to a plurality of organizations), the algorithmic logic 318 contains the logic that does not change over time and is generally common over all organizations that the system may apply to.

Although the embodiments described herein apply to meetings in an organization environment, one of skill in the art will appreciate that these techniques could be applied to other information management systems, eg., information management system for educational institutes to manage libraries, arrange course schedules with optimized resource (classrooms, lecture halls, labs and teaching facilities) utilization, and optimize teacher and student schedules. These techniques could also be applied to scheduling fitness courses and optimizing the use of fitness equipment within a gym.

Although embodiments have been described, those of skill in the art will appreciate that variations and modifications may be made without departing from the spirit and scope thereof as defined by the appended claims.

What is claimed is:

1. A system for supporting coordination of resources for events in an organization, comprising:
a knowledge component storing a resource-utilization model, the resource-utilization model comprising at least one ontology, each ontology comprising a respective schema and data stored according to the schema;
a knowledge acquisition component adapting the resource-utilization model in real-time in response to receiving data from various sources about resource utilization in the organization;
a domain reasoner adapting the resource-utilization model based on contents of a modifiable set of rules applied by the organization; and
a query endpoint receiving queries about resources for events and responding to the queries based on the resource-utilization model.

2. The system of claim 1, wherein the resource-utilization model comprises a meeting ontology storing meeting-related concepts and their interrelationships and a scheduling ontology storing scheduling-related concepts and their interrelationships.

3. The system of claim 2, wherein the meeting-related concepts comprise meetings and meeting-related resources.

4. The system of claim 3, wherein the meeting-related resources comprise at least one of rooms, people, equipment, software, multimedia resources, and networking resources.

5. The system of claim 4, wherein the equipment comprises at least one of one or more computers, a display screen, a projection system, and an interactive input system.

6. The system of claim 4, wherein the software comprises at least one of a voice bridge, a data link, and one or more meeting server.

7. The system of claim 2, wherein the scheduling-related concepts comprise schedules of meetings and of meeting-related resources.

8. The system of claim 7, wherein the schedules comprise blocks of time.

9. The system of claim 1, wherein the various sources of knowledge comprise at least one structured source of knowledge.

10. The system of claim 9, wherein the knowledge acquisition component has access to a predefined structure of the at least one structured source of knowledge thereby to acquire knowledge.

11. The system of claim 1, wherein the various sources of knowledge comprise at least one unstructured source of knowledge.

12. The system of claim 11, wherein the knowledge acquisition component comprises a learning component capable of inferring knowledge from the at least one unstructured source of knowledge thereby to acquire knowledge.

13. The system of claim 12, wherein the learning component executes one or more of: a machine learning algorithm, a natural language processing algorithm, a decision tree, and a neural network, for inferring knowledge from the at least one unstructured source of knowledge.

14. The system of claim 12, wherein the at least one unstructured source of knowledge comprises at least one of email files, meeting agenda files, and meeting minutes files.

15. The system of claim 1, wherein the knowledge component comprises at least one sensor identifying the location of one or more people associated with the organization.

16. The system of claim 15, wherein the at least one sensor comprises at least one RFID sensor at a respective location sensing the presence of one or more people at the location.

17. The system of claim 1, wherein the knowledge component comprise one or more software agents.

18. The system of claim 1, further comprising a meeting management application comprising:
a user interface;
a scheduler receiving user requests to schedule respective meetings via the user interface and in response generating a response to the respective user request based on the resource-utilization model.

19. The system of claim 18, wherein the scheduler comprises:
an algorithmic logic module embodying computer readable program code for generic scheduler functions; and
a rules logic module storing modifiable descriptive logic rules for organization-specific scheduler functions.

20. The system of claim 18, wherein the meeting management application further comprises a specialized data store for storing a copy of a subset of data stored in the knowledge component, wherein the scheduler generates a response to a respective user request based on the data stored in the specialized data store.

21. The system of claim 18, wherein the scheduler generates a response to a respective user request based on the data stored in the knowledge component.

22. The system of claim 19, wherein the meeting management application further comprises a learning engine modifying the descriptive logic rules in the rules logic module based on at least one of patterns of use of the meeting management application and adaptations to the resource-utilization model.

23. The system of claim 1, wherein the resource-utilization model comprises a resource reservation ontology storing resource reservation related concepts and their interrelationships.

24. The system of claim 23, wherein the resource reservation concepts comprise finite resources, people, and reservation times for the finite resources by the people.

25. The system of claim 24, wherein the finite resources are at least one of books and equipment.

26. The system of claim 25, wherein equipment comprises at least one machine.

27. The system of claim 1, wherein the knowledge component comprises at least one triplestore into which the data is stored.

28. The system of claim 18, wherein the specialized data store is a triplestore.

29. The system of claim 28, wherein the knowledge acquisition component transforms received data into triples format for storing in the triplestore.

30. A method for supporting coordination of resources for events in an organization, comprising:
providing a resource-utilization model, the resource-utilization model comprising at least one ontology, each ontology comprising a respective schema and data stored according to the schema;
adapting the resource-utilization model in real-time in response to receiving data from various sources about resource utilization in the organization;
adapting the resource-utilization model based on contents of a modifiable set of rules applied by the organization;
receiving queries about resources for events; and
responding to the queries based on the resource-utilization model.

31. The method of claim 30, further comprising:
providing in the resource-utilization model a meeting ontology that stores meeting-related concepts and their interrelationships, and a scheduling ontology storing scheduling-related concepts and their interrelationships.

32. The method of claim 31, wherein the meeting-related concepts comprise meetings and meeting-related resources.

33. The method of claim 32, wherein the meeting-related resources comprise at least one of rooms, people, equipment, software, multimedia resources, and networking resources.

34. The method of claim 33, wherein the equipment comprises at least one of one or more computers, a display screen, a projection system, and an interactive input system.

35. The method of claim 33, wherein the software comprises at least one of a voice bridge, a data link, and one or more meeting server.

36. The method of claim 31, wherein the scheduling-related concepts comprise schedules of meetings and of meeting-related resources.

37. The method of claim 36, wherein the schedules comprise blocks of time.

38. The method of claim 30, wherein the various sources of knowledge comprise at least one structured source of knowledge.

39. The method of claim 38, wherein the knowledge acquisition component has access to a predefined structure of the at least one structured source of knowledge thereby to acquire knowledge.

40. The method of claim 30, wherein the various sources of knowledge comprise at least one unstructured source of knowledge.

41. The method of claim 40, wherein the knowledge acquisition component comprises a learning component capable of inferring knowledge from the at least one unstructured source of knowledge thereby to acquire knowledge.

42. The method of claim 41, wherein the learning component executes one or more of: a machine learning algorithm, a natural language processing algorithm, a decision tree, and a neural network, for inferring knowledge from the at least one unstructured source of knowledge.

43. The method of claim 41, wherein the at least one unstructured source of knowledge comprises at least one of email files, meeting agenda files, and meeting minutes files.

44. The method of claim 30, further comprising providing to the knowledge component at least one sensor identifying the location of one or more people associated with the organization.

45. The method of claim 44, wherein the at least one sensor comprises at least one RFID sensor at a respective location sensing the presence of one or more people at the location.

46. The method of claim 30, wherein the knowledge component comprise one or more software agents.

47. The method of claim 30, further comprising providing a meeting management application comprising:
a user interface;
a scheduler for receiving user requests to schedule respective meetings via the user interface and in response generating a response to the respective user request based on the resource-utilization model.

48. The method of claim 47, wherein the scheduler comprises:
an algorithmic logic module embodying computer readable program code for generic scheduler functions; and
a rules logic module storing modifiable descriptive logic rules for organization-specific scheduler functions.

49. The method of claim 47, wherein the meeting management application further comprises a specialized data store for storing a copy of a subset of data stored in the knowledge component, wherein the scheduler generates a response to a respective user request based on the data stored in the specialized data store.

50. The method of claim 47, wherein the scheduler generates a response to a respective user request based on the data stored in the knowledge component.

51. The method of claim 48, further comprising providing a learning engine modifying the descriptive logic rules in the rules logic module based on at least one of patterns of use of the meeting management application and adaptations to the resource-utilization model.

52. The method of claim 30, wherein the resource-utilization model comprises a resource reservation ontology storing resource reservation related concepts and their interrelationships.

53. The method of claim 52, wherein the resource reservation concepts comprise finite resources, people, and reservation times for the finite resources by the people.

54. The method of claim 53, wherein the finite resources are at least one of books and equipment.

55. The method of claim 54, wherein equipment comprises at least one machine.

56. The method of claim 30, wherein the knowledge component comprises at least one triplestore into which the data is stored.

57. The method of claim 47, wherein the specialized data store is a triplestore.

58. The method of claim 57, wherein the knowledge acquisition component transforms received data into triples format for storing in the triplestore.

59. A computer readable medium embodying a computer program for supporting coordination of resources for events in an organization, the computer program comprising:
computer program code providing a resource-utilization model, the resource-utilization model comprising at least one ontology, each ontology comprising a respective schema and data stored according to the schema;
computer program code adapting the resource-utilization model in real-time in response to receiving data from various sources about resource utilization in the organization;
computer program code adapting the resource-utilization model based on contents of a modifiable set of rules applied by the organization;
computer program code receiving queries about resources for events; and
computer program code responding to the queries based on the resource-utilization model.
